(19) United States
(12) Patent Application Publication
(10) Pub. No.: US 2016/0329797 A1
(43) Pub. Date: Nov. 10, 2016

(54) BRUSHLESS DC MOTOR

(71) Applicant: HONDA MOTOR CO., LTD., Tokyo (JP)

(72) Inventors: Satoshi Kono, Saitama (JP); Hirotomi Nemoto, Saitama (JP); Michiyo Ishikawa, Saitama (JP); Toshitsugu Tanigawa, Saitama (JP)

(73) Assignee: HONDA MOTOR CO., LTD., Tokyo (JP)

(21) Appl. No.: 15/108,153

(22) PCT Filed: Oct. 27, 2014
(86) PCT No.: PCT/JP2014/078447

§ 371 Date: Jun. 24, 2016

(30) Foreign Application Priority Data
Dec. 26, 2013 (JP) 2013-269168
May 22, 2014 (JP) 2014-105785

(51) Int. Cl. H02K 21/38; H02K 1/24; H02K 29/03; H02K 1/17; H02K 1/14

(52) U.S. Cl. CPC H02K 21/38; H02K 1/17; H02K 1/141; H02K 29/03; H02K 1/246; H02K 2213/03

(57) ABSTRACT

A low-cost brushless DC motor is provided with high efficiency operation and low torque pulsation. The brushless DC motor includes a stator around which an inductive coil is wound, a rotor which is housed in the stator and which can rotate in a prescribed direction, and pairs of magnets which are on opposite sides of the rotation shaft of the rotor and which are fixed to the stator.

### TECHNICAL FIELD

The present invention relates to a brushless DC motor.

### BACKGROUND ART

Conventionally, DC brush motors including brushes and a commutator have been mainly used for electric pumps in automobiles, etc. The DC brush motor has an advantage effect in that the cost is low and the structure is simple.

On the other hand, brushless DC motors are known which operate without the brushes and the commutator by applying rectangular wave voltages to coils by electrically controlling switching devices between ON and OFF. The use of the brushless DC motor provides keeping reliability in electrical connection irrespective of the period of use.

In the conventional brushless DC motors there are brushless DC motors using three-phase AC power supply and a single-phase AC power supply.

The three-phase brushless DC motor has such a structure as to generate a rotating magnetic field by applying rectangular wave voltages having different phases to three-phase coils. In this case, six switching devices (for example, FET: Field effect transistors) become necessary to apply positive and negative voltages to three-phase coils.

Further, the single-phase brushless DC motor uses an auxiliary coil (shading coil) because the single-phase brushless DC motor cannot start rotation if such an additional structure is not added.

Patent Document 1 discloses a shading coil type induction motor including a stator having a shading coil, a rotor inserted into a rotor housing hole in the stator for rotation drive, and an excitation coil.

### PRIOR ART

### Patent Document

Patent Document 1: JP 5090855

### SUMMARY OF INVENTION

### Problem to be Solved by Invention

However, the brush DC motor has a defect in electrical connection between the brush and the commutator due to aging degradation in the brush because of mechanical contacts with a commutator.

Further, the three-phase brushless DC motor requires six switching devices to apply positive and negative voltages to the three-phase coils as described above, which results in increase in the manufacturing cost compared with the brush DC motor.

Further, the shading coil type induction motor disclosed in Patent Document 1 has a defect due to a high manufacturing cost because the auxiliary coil (shading coil) becomes necessary. In addition, there is a problem in that for the period for which no induction current flows in the shading coil out of one cycle, a negative torque is generated in the rotor, so that a running efficiency is low.

Accordingly, the present invention aims to provide a brushless DC motor capable of a high efficiency operation at a low cost.

### Means for Solving Problem

To achieve the aim, each of the invention is configured as follows:

A brushless DC motor includes:

a stator around which an exciting coil is wound;

a rotor that is housed in the stator and rotatable in a predetermined direction; and

a pair of magnets fixed on the stator, the magnets in the pair facing across a rotation shaft of the rotor as a center.

Other means will be described in the “MODES FOR CARRYING OUT INVENTION”.

### Advantageous Effect of Invention

According to the present invention, there is provided a brushless motor providing a high efficiency operation in which torque pulsation is reduced.

### BRIEF DESCRIPTION OF DRAWINGS

FIG. 1 is a cross sectional drawing illustrating an example of a structure of a brushless DC motor according to a first embodiment of the present invention.

FIGS. 2A to 2D are drawings generally illustrating a rotation operation principle of the brushless DC motor according to the first embodiment of the present invention, wherein FIG. 2A illustrates a position of the rotor and a main magnetic flux at a first stable point; FIG. 2B illustrates the main magnetic flux in the rotor and the stator when a current flows in a first direction through the exciting coil at the first stable point; FIG. 2C illustrates a position of the rotor and the main magnetic flux at a second stable point; and FIG. 2D illustrates the main magnetic flux in the rotor and the stator when the current flows in a second direction through the exciting coil at the second stable point.

FIG. 3 is a drawing illustrating maximum and minimum inductance between the rotor and the stator of the brushless DC motor according to the first embodiment of the present invention.

FIGS. 4A to 4D are drawings illustrating examples of shapes of the rotor in which a facing area to the rotor peripheries is varied. FIG. 4A shows the example having the facing area S1. FIG. 4B shows the example having the facing area S2. FIG. 4C shows the example having the facing area S3. FIG. 4D shows the example having the facing area S4.

FIG. 5 is a chart showing inductance differences between the rotor and stator when the facing area to the rotor peripheries is varied.

FIGS. 6A to 6D are drawings illustrating examples of shapes of the rotor in which a gap between the rotor base and a center of magnet is varied. FIG. 6A shows the example when the gap is G1. FIG. 6B shows the example when the gap is G2. FIG. 6C shows the example when the gap is G3. FIG. 6D shows the example when the gap is G4.

FIG. 7 is a chart showing inductance differences between the rotor and stator when the gap between the rotor base and the center of magnet is varied.

FIGS. 8A to 8C are drawings illustrating examples of shapes of the rotor in which a distance between two rotor peripheries is varied. FIG. 8A shows the example having the distance L11. FIG. 8B shows the example having the distance L12. FIG. 8C shows the example having the distance L13.

FIGS. 9A to 9D are drawings illustrating structures including rotor gaps, operations, and functions. FIG. 9A shows a shape of the rotor without the rotor gap. FIG. 9B shows a shape of the rotor including a plurality of first rotor gaps and a second rotor gap. FIG. 9C shows a state of the main magnetic flux transmitting through the rotor without the rotor gaps. FIG. 9D shows a state of the main magnetic flux transmitting the rotor including a second rotor gap.

FIG. 10A is a chart showing an example of torque characteristic of the brushless DC motor without the rotor gaps at the rotor peripheries.

FIG. 10B is a chart shown in an example of a torque characteristic of the brushless DC motor with the rotor gaps at the rotor peripheries.

FIGS. 11A to 11D are drawings showing structures regarding a stator notch, operations and functions. FIG. 11A shows a shape of the sedater without the stator notch. FIG. 11B shows a shape of the stator with first and second stator notches. FIG. 11C shows a state of the main magnetic flux transmitting through the stator without the stator notch. FIG. 11D shows a state of the main magnetic flux transmitting through the stator with the first and second stator notches.

FIG. 12A is a chart of an example of a torque characteristic of the brushless DC motor without the stator notch.

FIG. 12B is a chart of an example of a torque characteristic of the brushless DC motor with the stator notch.

FIGS. 13A and 13B are drawings illustrating influence on torque variations in accordance with the shape of the extending part and the presence and absence of the second stator notch. FIG. 13A shows a shape of the extending part faces circular arc part of the magnet on the inner side like circular circumference part of the rotor periphery. FIG. 13B shows a shape of the extending part with the second stator notch, the extending part which separates from the arc part on the inner side of the magnet as a point thereof is going to a tip of the extending part.

FIGS. 14A and 14B are drawings illustrating influence on torque variations in accordance with the presence and absence of the second stator notch. FIG. 14A shows a shape in the case of no second stator notch. FIG. 14B shows a shape in the case where there is a second stator notch.

FIG. 15A is a chart of an example of the torque characteristic of the brushless DC motor in the case where the shape of the extending part faces the arc part of the magnet.

FIG. 15B is a chart of an example of the torque characteristic of the brushless DC motor in the case where the extending part separates from the arc part on the inner side of the magnet as a point thereon is going to a tip of the extending part and there is the second stator notch.

FIG. 16A is a chart illustrating an example of a torque characteristic of the brushless DC motor in the case of no second stator notch.

FIG. 16B is a chart illustrating an example of a torque characteristic of the brushless DC motor in the case that there is the second stator notch.

FIG. 17 is a cross-sectional drawing taken along a direction at a right angle with the rotation shaft of the brushless DC motor according to the second embodiment of the present invention.

FIGS. 18A to 18D are drawings illustrating a rotating operation of the brushless DC motor according to the second embodiment of the present invention. FIG. 18A shows a position of the rotor and the main magnetic flux of the stator at a first stable point. FIG. 18B shows a position of the rotor at a second stable point and the main magnetic flux of the rotor and the stator at a second stable point. FIG. 18C shows a position of the rotor when a current is allowed to flow in a second direction in the exciting coil and the main magnetic flux of the rotor and the stator at a third stable point. FIG. 18D shows a position of the rotor and the main magnetic flux of the stator at a fourth stable point.

FIGS. 19A and 19B are cross-sectional diagrams more specifically illustrating shapes of the magnets for the brushless DC motor according to the second embodiment. FIG. 19A is drawn to arc more specifically show the vicinity of the magnets shown in FIG. 17 and FIG. 19B is a perspective view to more intelligibly show the shape of the magnets.

FIGS. 20A and 20B are drawings showing the structure of the brushless DC motor according to the third embodiment of the present invention. FIG. 20A is a cross-sectional diagram. FIG. 20B is a perspective view including the cross-section shown in FIG. 20A.

FIG. 21 is a cross-sectional diagram of the brushless DC motor according to a fourth embodiment of the present invention.

### MODES FOR CARRYING OUT INVENTION

Modes for carrying out the invention (hereinafter referred to as embodiments) are described in detail occasionally referring to the drawings below.

### First Embodiment

### Structure of Brushless DC Motor

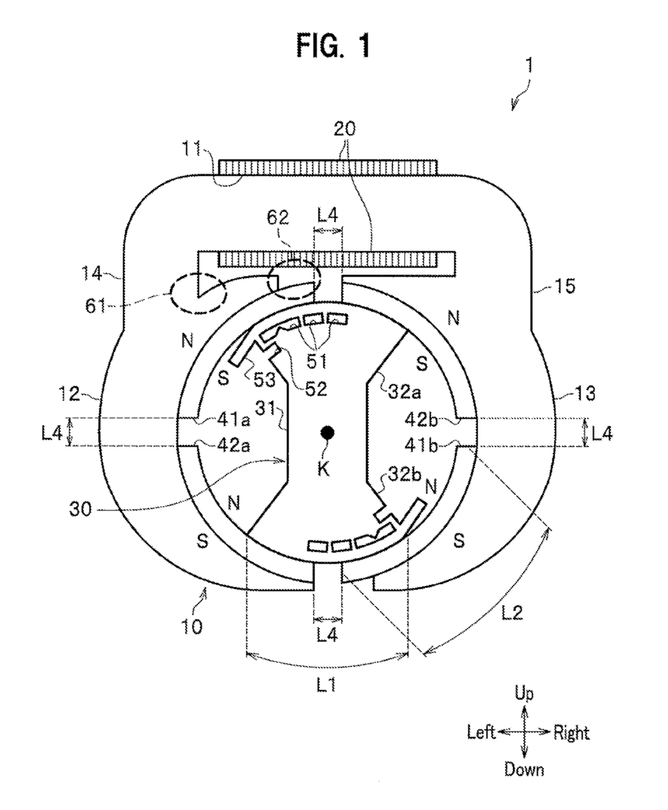

FIG. 1 is a cross-sectional drawing illustrating an example of a structure of a brushless DC motor according to a first embodiment of the present invention.

In FIG. 1, a brushless DC motor 1 has an inner rotor type structure in which a rotor 30 is housed in a stator 10, and the rotor 30 is rotatably supported through the rotation shaft K inside the stator 10 (inside in a diametrical direction with reference at a rotation shaft K). The rotation shaft K is connected to a load (not shown).

The brushless DC motor 1 includes the stator 10 around which an excitation coil 20 is wound, the rotor 30 being rotatable counterclockwise and housed in the stator 10, and magnets 41a, 42a, 41b, 42b fixed on an inner circumferential surface of the stator 10 substantially equi-distantly.

With the structure described above, the brushless DC motor 1 has a function to generate a torque for counterclockwise rotation drive of the rotor 30 using synthesized magnetic flux of the magnetic flux according to a current flowing through the excitation coil 20 and magnetic flux generated by the four magnets 41a, 42a, 41b, 42b fixed on the internal circumferential surface of the stator 10. Operation will be described later.

### <<Stator>>

The stator 10 comprises a magnetic substance (for example, silicon steel plates) for housing the rotor 30 inside in the diametrical direction, and includes a coil winding member 11, a first housing member 12, a second housing member 13, a first yoke 14, and a second yoke 15.

The coil winding member 11 comprises a bar like member extending in a left-right direction around which the excitation coil 20 is wound.

The first housing member 12 has a substantially C-shape in cross-sectional view and extends in parallel to the rotation shaft K (in face side-deep side direction of paper). The first housing member 12 is connected to the left end of the coil winding member 11 through the first yoke 14.

The second housing member 13 has a substantially inverted C-shape in cross-sectional view and extends in parallel to the rotation shaft K. The second housing member 13 is connected to the right end of the coil winding member 11 through the second yoke 15.

More specifically, the first housing member 12 and the second housing member 13 formed integrally with the coil winding member 11 through the yoke 14 and the second yoke 15 form a housing space in a circular cylindrical column with a center at the rotation shaft K such that the rotor 30 is interposed between the first housing member 12 and the second housing member 13 from the left side and the right side.

Further, the first housing member 12 is formed to have a thickness decreasing as going to the upper and lower ends. This limits amounts of the magnetic flux passing through parts near the upper end and the lower end of the first housing member 12. This is true for the second housing member 13.

Further, an upper end of the first housing member 12 and the upper end of the second housing member 13 are spaced in the left-right direction by a sum of a distance (interval) L4 and a length in the left-right direction of the second stator notch 62.

Similarly, a low end of the first housing member 12 and the lower end of the second housing member 13 are spaced in the left-right direction by a sum of a distance (interval) L4 and the length in the left-right direction of the second stator notch 62.

These gaps cause magnetic flux generated by the current in the excitation coil 20 necessarily to pass through the rotor 30. In other words, the magnetic flux generated by the current flowing through the excitation coil 20 is caused not to close only within the stator 10.

There is a first stator notch 61 formed by notching a part of the magnetic substance of the first housing member 12 where the yoke 14 and the first housing member 12 are connected near the lower side of the left end of the member around which the excitation coil 20 is wound.

There is a second stator notch 62 formed by notching a part of the magnetic substance of the first housing member 12 near a lower side of a substantially middle of the member around which the excitation coil 20 is wound and near the right end of the magnet 41a.

The first stator notch 61 and the second stator notch 62 function as high magnetic resistors having high magnetic resistances.

The functions of the first stator notch 61 and the second stator notch 62 will be described later.

Each of the magnets 41a, 42a, 41b, 42b is a permanent magnet having an arc shape in cross-sectional view.

The magnets 41a, 42a are fixed on the inner circumferential surface in the diametrical direction of the first housing member 12 of the stator 10 at a left upper side thereof and at a left lower side thereof.

The magnets 42b, 41b are fixed to the inner circumferential surface in the diametrical direction of the second housing member 13 of the stator 10 at left upper side thereof and at left lower side thereof.

The magnet 41a, 42b have N poles on the side of the stator 10 and S poles on the side of the rotor 30.

The magnet 42a, 41b have S poles on the side of the stator 10 and N poles on the side of the rotor 30.

As described above, the magnets 41a, 41b face the magnet 42a, 42b and pairs across the rotation shaft K, respectively.

The magnets 41a, 42a, 41b, 42b are formed in arc shapes, and lengths of the arcs (arc length) are L2.

Further, the magnets 41a and 42a, the magnets 42a and 41b, the magnets 41b and 42b, and the magnets 42b and 41a are spaced at a predetermined distance (interval) L4.

Further, each of the magnets 41a, 42a, 41b, 41b is arranged such that magnetic flux generated by its own is additionally strengthen with magnetic flux generated by another magnet adjacent to the magnet in the inner circumferential direction of the first housing member 12 and the second housing member 13 in such a condition that a magnetically connected condition through an extending part 53 of the rotor 30 as described later. Functions and operations of the magnets 41a, 42a, 41b, 42b, the rotor 30, and the extending part 53 will be described later.

### <<Rotor>>

The rotor 30 is a rotor rotatable counterclockwise by the torque according to the magnetic flux distribution within the brushless DC motor 1 and housed in the housing space having the circular cylindrical pillar shape between the first housing member 12 and the second housing member 13.

The rotor 30 is a magnetic substance (for example, an iron core) which is formed such that a rotor base 31, rotor peripheries 32a, 32b, and the extending part 53 are integrally shaped.

Further, there are first rotor gaps (high magnetic resistance part) 51 on a circular circumferential side (a side of magnet of the stator) of the rotor periphery 32a which are gaps for limiting inflow of the magnetic flux. Further, in FIG. 1, the first rotor gap (high magnetic resistance part) 51 are formed including a plurality of gaps having a window shapes.

Further on a side surface of the rotor periphery 32a, there is a second rotor gap (high magnetic resistance part) 52 which is a gap or notch for limiting inflow of the magnetic flux by increase in the magnetic resistance.

At a left end of the rotor periphery 32a on a side of the circular circumferential side (side of the magnet of the stator), there is the extending part 53 which a magnetic substance which causes the counterclockwise rotation. The extending part 53 has a shape thinner than the shape of the rotor periphery 32a. The thinner shape is made to prevent magnetic flux having an intensity more than a necessary intensity from passing therethrough.

Further, the extending part 53 has such a shape as to more separate from the magnets 41a, 42a, 41b, 42b of the stator 10 as the location goes to the tip (left end). The reason for this will be described later.

Also the rotor periphery 32b is provided with the first rotor gap 51, the rotor gaps 52, and the extending part 53. The rotor peripheries 32a, 32b have point-symmetric shapes regarding the rotation shaft K.

Further, in a cross-sectional view, the extending part 53, the first rotor gap 51, and the rotor gaps 52 are formed on a left end side of the 32a (32b) of the rotor 30. As described above, the extending part 53, the first rotor gap 51, and the rotor gaps 52 are formed on the left end side of the rotor peripheries 32a 32b, which provides a structure suitable for the operation of counterclockwise rotation of the rotor 30.

Detailed descriptions of operations and advantageous effect regarding the first rotor gap 51, the second rotor gaps 52, and the extending part 53 will be described later.

Parts (circular circumference parts) of the rotor peripheries 32a, 32b of the rotor 30 facing the magnets (41a, 42a, 41b, 42b) are each formed in a circular arc shape having a length (circular arc length) L1. It is desirable that the length L1 of the circular arc (circular arc length) of the rotor peripheries 32a, 32b is substantially equal to the length L2 of the circular arc (the circular arc length) L2 of the magnets 41a, 42a, 41b, 42b (L1=L2).

It is noted that the length (circular arc length) L1 of the rotor peripheries 32a, 32b does not include a length of the extending part 53.

Further, it is desirable that an area of the rotor peripheries 32a, 32b and an area of the magnets (41a, 41b, 42b) facing each other are substantially equal to each other.

The reason why it is desirable that the lengths and areas of the rotor peripheries 32a, 32b and the magnets facing each other are equal to each other, respectively, will be described later.

### <Outline of Rotation Operation Principle>

Next, outline of the rotation operation principle of the brushless DC motor 1 is described below.

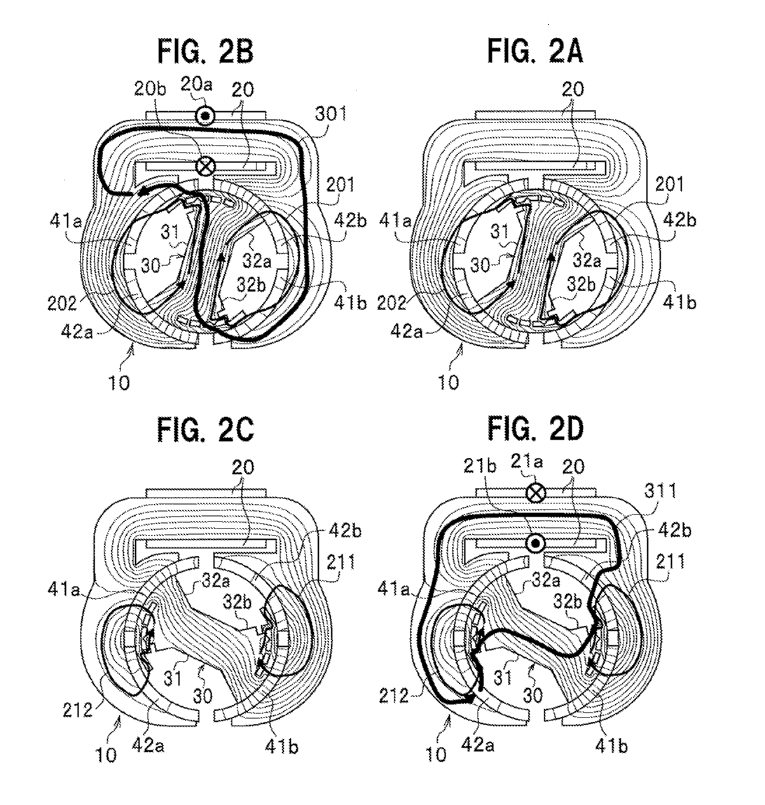

FIGS. 2A to 2D are drawings generally illustrating a rotation operation principle of the brushless DC motor 1 according to the embodiment of the present invention, wherein FIG. 2A illustrates a position of the rotor and a main magnetic flux at a first stable point; FIG. 2B illustrates the main magnetic flux in the rotor and the stator when a current flows in a first direction through the exciting coil at the first stale point; FIG. 2C illustrates a position of the rotor and the main magnetic flux at a second stable point; and FIG. 2D illustrates the main magnetic flux in the rotor and the stator when the current flows in a second direction through the exciting coil at the second stable point.

Further, in FIGS. 2A, 2B, 2C, and 2D, magnetic flux caused by the stator 10, the rotor 30, and the excitation coil 20 are generally shown with a plurality of thin lines. In the drawings, magnetic flux leakage which does not contribute to rotation of the rotor 30, are omitted. In addition, there may be a case where it is difficult to understand the operation from the magnetic flux distribution with thin lines, in which case, synthesized magnetic flux illustrated from the magnetic flux distribution are shown as “main magnetic flux”.

In a closed magnetic circuit of the rotor 30, the magnets 41a, 42a, 41b, 42b, and the stator 10, the main magnetic flux is shown with thick lines as main magnetic flux 201, 202 (in FIGS. 2A, 2B), and main magnetic flux 211, 212 (in FIGS. 2C, 2D) is shown with thick lines. Further, main magnetic flux in a closed magnetic circuit formed by the excitation coil 20, the stator 10, and the rotor 30 are shown as magnetic flux 301, 311 with a thick line (see FIG. 2B), and with a thick line (see FIG. 2D).

In FIG. 2A, no current flows in the excitation coil 20. In this instance, a main magnetic flux 202 is generated through the rotor 30, the magnet 41a, the stator 10 and the magnet 42a. Further, the main magnetic flux 201 is generated through the rotor 30, the magnet 42b, the stator 10, and a magnet 41b. In addition, polarities (N, S) of the magnets 41a, 42a, 42b, 42b are as shown in FIG. 1 or as described above.

A most part of the part of the rotor periphery 32a of the rotor 30 able to face the magnets the magnet 42b faces the magnet 42b, and another part of the part of the rotor periphery 32a able to face the magnets faces the magnet 41a. This state provides a stable point having no rotation because torque balance is achieved in which a counterclockwise ration torque balance with clockwise rotation torque regarding the rotor 30.

The torque balance is achieved in such a state that a part of the part facing the magnet of the rotor peripheries 32a faces the magnet 41a. This relates to an operation of the extending part 53, the first rotor gap 51 which becomes a high magnetic resistor, and the second rotor gaps 52.

It is assumed that the extending part 53 (see FIG. 1) is longer than a distance L4 between magnets adjoining each other (for example, the magnets 42b. 41a), there occurs such a state that the extending part 53 overlaps with a pair of the magnets 41a, 42b in the diametrical direction when the rotor 30 is rotated. Accordingly, between a pair of the magnets 41a, 42a and between other magnets 41b, 42b magnetic coupling is promoted and the main magnetic flux 202, 201 are formed and as described above, in FIG. 2A, torque balance is formed.

Operations of the first rotor gap 51, the second rotor gaps 52, which act as magneto-resistive parts is described later.

Further, the state that the most part of the part of the rotor periphery 32a able to face the magnets the magnet 42b face the magnet 42b, and another part of the part of the rotor periphery 32a able to face the magnets faces the magnet 41a, will be also described later. Duplicated description is omitted.

FIG. 2B shows a state in which a current flows through the excitation coil 20 in first directions 20a, 20b in the state of the first stable point shown in FIG. 2A. Further, “the first direction 20a” means a direction from a deep side regarding the paper of the drawing to our side and “the second direction 20b” means a direction from our side to the deep side regarding the paper of the drawing.

A current flow in the excitation coil 20 in the first directions 20a, 20b generates new main magnetic flux 301 through the stator 10, the magnet 41b, the rotor 30, and the magnet 41a.

As shown in FIG. 2B, the main magnetic flux 301 is added to the main magnetic flux 201, 202 at the first stable point, so that a magnetic flux density at the rotor peripheries 32a, 32b near the extending part 53 (see FIG. 1) increases (magnetic flux density is concentrated). When the magnetic flux density increases, a stress in the magnetic field increases (Maxwell stress), so that the balance in torque shifts, which generates a force causing a counterclockwise rotation.

As a result, the rotor 30 rotates counterclockwise, so that the state goes to the state shown in FIG. 2C showing a second stable point.

As described above, FIG. 2C indicates a position of the rotor 30 at the second stable point and the main magnetic flux 211, 212. In FIG. 2C, no current flows through the excitation coil 20.

When a rotational position reaches the vicinity of the second stable point as a result of the counterclockwise rotation from the first stable point, a torque balance is obtained in a state of the second stable point in which no rotation occurs as a stable point.

More specifically in the state shown in FIG. 2C, the rotor periphery 32a overlaps with the magnet 41a in the diametrical direction, and the extending part 53 overlaps with the magnet 42a in the diametrical direction. Accordingly, this promotes a magnetic connection between a pair of the magnets 41a, 42a, so that a main magnetic flux 212 is formed.

Further, the rotor peripheries 32b overlaps with the magnet 41b in the diametrical direction, and the extending part 53 overlaps with the magnet 42b in the diametrical direction. Accordingly, this promotes a magnetic connection between a pair of the magnets 41b, 42b.

The main magnetic flux 212 and the 211 are formed, so that a torque balance is provided in FIG. 2C.

Further, in the state shown in FIG. 2C, the most part of the part of the rotor periphery 32a being able to face the magnets the magnet 41a faces the magnet 42a, and another part of the part of the rotor periphery 32a being able to face the magnets faces the magnet 42a.

FIG. 2D shows a state in which a current flows through the excitation coil 20 in second directions 21a, 21b in the state of the second stable point shown in FIG. 2C. Further, “the second direction 21a” means a direction to a deep side regarding the paper of the drawing from our side and “the second direction 21b” means a direction to our side from the deep side regarding the paper of the drawing.

The current flowing through the excitation coil 20 in the second directions 21a, 21b, which generates a new main magnetic flux 311 through the stator 10, the magnet 42a, the rotor 30, and the magnet 42b.

As shown in FIG. 2D, the main magnetic flux 311 is added to the main magnetic flux 211, 212 at the second stable point, so that a magnetic flux density at the rotor peripheries 32a, 32b near the extending part 53 (see FIG. 1) increases (magnetic flux density is concentrated). When the magnetic flux density increases, a stress in the magnetic field increases (Maxwell stress), so that the balance in torque shifts, which generates a force causing a counterclockwise rotation.

As a result, the rotor 30 rotates counterclockwise, so that the state goes to the state shown in FIG. 2 showing a second stable point.

As described above, the current is caused to flow alternately in the first direction, and the second direction. This causes counterclockwise rotation in the brushless DC motor 1 in an order of from states in FIG. 2A, FIG. 2B, FIG. 2C, FIG. 2D, and FIG. 2A.

Further, it is possible to perform control of the excitation coil 20 one step by one step, to stop at every stable point, or to make the counterclockwise continuous rotation by successively making alternating current flow in the excitation coil 20.

Further, in the above description, it is assumed that the state shown in FIG. 2A is in a first stable point and the state shown in FIG. 2C is in a second stable point. The rotor 30 rotates by 90 degrees from the state shown in FIG. 2A to the state shown in FIG. 2C. In other words, the rotor 30 passes through the stable point every 90-degree rotation, so that there are four stable points per one rotation. However, because a shape of the rotor is point-symmetry on the rotation shaft K, there is no difference in external appearance though the rotor rotates around another stable point remote by 180 degrees. Accordingly, in FIGS. 2A, 2B, 2C, and 2D, only two stable points are shown for a brief explanation.

### <Maximum and Minimum Inductance Between Rotor and Stator>

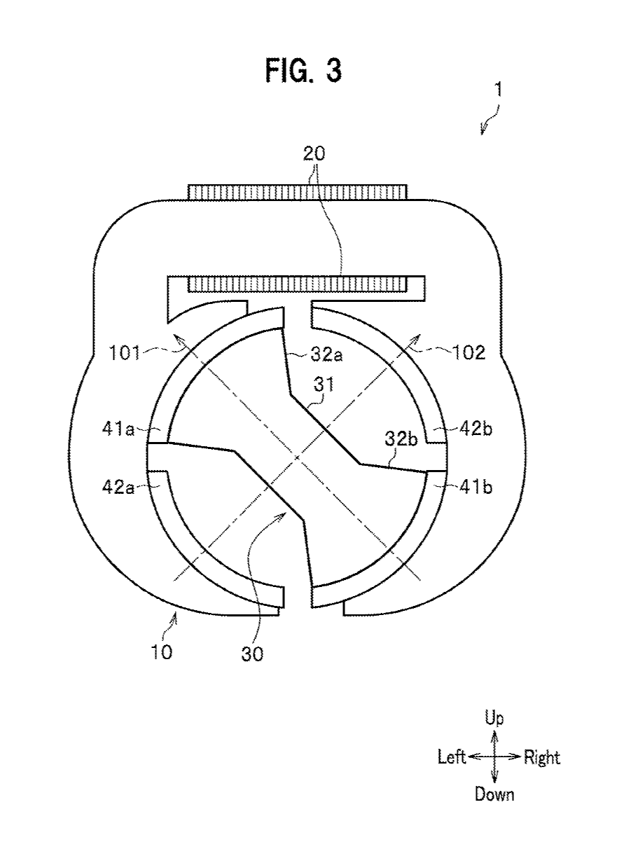

Next the maximum and the minimum inductances are described below. The inductance between the rotor and the stator is an equivalent inductance calculated from a relationship between voltage and current in the excitation coil 20 (see FIGS. 1 and 3). The equivalent inductance is called an inductance between the rotor and the stator because the equivalent inductance varies in accordance with a positional relation between the rotor 30 and the stator 10.

FIG. 3 is provided for explaining the maximum and minimum inductances between the rotor 30 and the stator 10 of the brushless DC motor 1 according to the embodiment.

When the rotor peripheries 32a, 32b of the rotor 30 face the magnets 41a, 41b, respectively with arcs thereof generally overlap each other, the magnetic flux between the rotor 30 and the stator 10 has a highest permeability, so that the inductance between the rotor and the state maximized.

A center axis of the rotor peripheries 32a, 32b of the rotor 30 is assumed as a direction 101.

The minimum inductance between the rotor 30 and the stator 10 occurs when the center axis orients a direction perpendicular to the direction 101, i.e., the direction 102 in FIG. 3.

In a direction 102, the magnetic flux is hard to transmit between the rotor 30 and the stator 10, so that the inductance becomes maximum.

However, when the symmetry is not satisfied because any of the first rotor gap 51, the second rotor gaps 52, the extending part 53, etc. described above with reference to FIG. 1 faces the rotor peripheries 32a, 32b, a position provides the maximum inductance may shift from the direction 101 in FIG. 3.

The maximum inductance or the minimum inductance depends on the shape of the rotor 30. The larger the difference between the maximum inductance and the minimum inductance is, the larger the rotation torque of the brushless DC motor 1 becomes. In addition, an energy efficiency of the brushless DC motor 1 increases, which provides a high efficiency operation efficiency (output torque to input power).

<Inductance Difference in Accordance with Shape of Rotor>

When the shape of the rotor 30 shown in FIG. 1 or FIG. 3 is modified, the maximum inductance and the minimum inductance vary, respectively and a difference in inductance between the maximum inductance and the minimum inductance also varies.

Next, examples of the rotor 30 of which shape is varied are shown and it is shown how the difference in the inductance between the maximum inductance and the minimum inductance varies in each of the cases.

### <<Relationship Between Facing Area Between the Magnet and the Rotor Periphery and the Inductance Difference>>

A first example is shown, in which the shape of the rotor 30 is varied, and a relation regarding the facing area between the magnet 41a (or the magnet 42a, 41b, 42b) and the rotor periphery 32a or 32b is shown below.

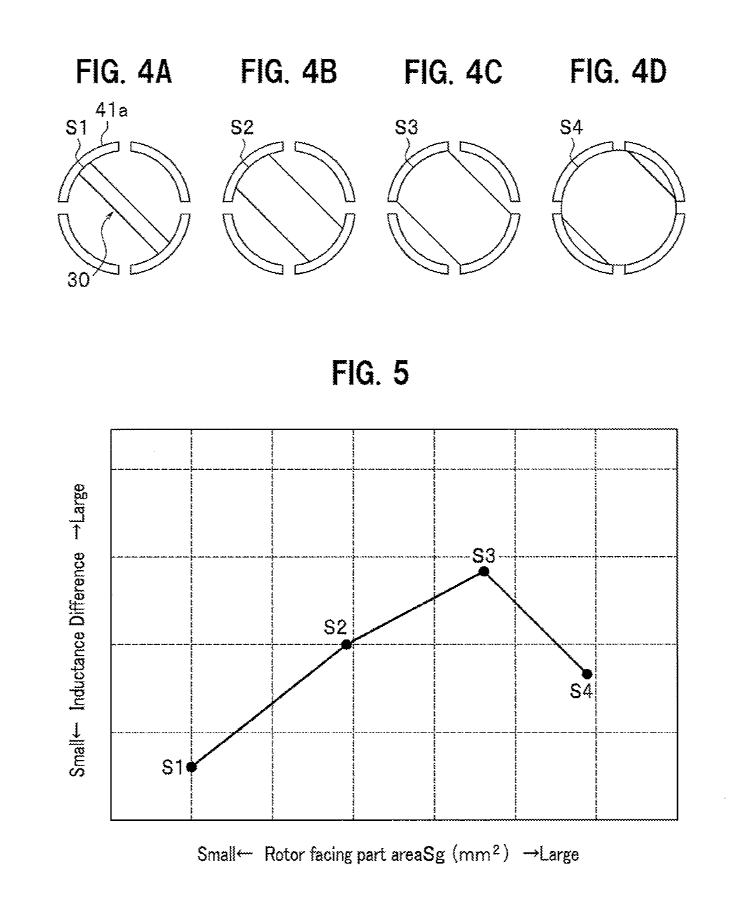

FIGS. 4A to 4D show examples in which the area of facing surface between the magnet 41a (see FIGS. 1 and 3) and the rotor peripheries 32a (see FIG. 1) are varied. In FIG. 4A, the area of facing surfaces is S1, in FIG. 4B, the area is S2, in FIG. 4C, the area is S3, and in FIG. 4D the area is S4.

In FIGS. 4A and 4B, a relation between arc length L1 (see FIG. 1) of circularly circumferential portion of the rotor periphery 32a (see FIG. 1) facing the magnet 41a (see FIG. 1) and a circular arc length L2 (see FIG. 1) of the magnet 41a (see FIG. 1) is L2>L1. Further, in FIG. 4C, L2=L1, that is, a circular arc length of the rotor periphery is equal to a circular arc length of the magnet. Further, in FIG. 4D, the circular arc length of the rotor periphery is greater than the circular arc length of the magnet.

In FIGS. 4A to 4D, when it is assumed that thicknesses of the rotor peripheries are the same, a magnitude relation in the facing area of the rotor peripheries are equal to that in the circular arc length of the rotor periphery.

Hereinafter, description is made with assumption that the magnitude relation in the facing area of the rotor peripheries are equal to that in the circular arc length of the rotor periphery.

FIG. 5 is a chart of an example indicating a relation between the the maximum inductance and the minimum inductance between the rotor and the stator when the facing area between the magnet 41a (see FIGS. 1 and 3) and the rotor periphery 32a (see FIG. 1).

In FIG. 5, the axis of abscissa represents the facing area of the magnet 41a (or 42a, 41b, 42b) and the rotor periphery 32a (or 32b). In FIG. 5, the facing area is represented by “rotor facing part area Sg (mm²)”. The axis of ordinate represents a difference between the maximum inductance and the minimum inductance between the rotor and the stator. In FIG. 5, it is represented by “inductance difference”.

In FIG. 5, characteristic points shown with “S1”, “S2”, and “S3” correspond to shapes shown in FIGS. 4A to 4C, respectively.

In FIG. 5, the characteristic point of S3 indicates that the inductance difference is largest. The characteristic at the point of the facing area S3 is the characteristic when the facing area is S3 between the magnet 41a (or 42a, 41b, 42b) and the rotor periphery 32a (or 32b) as shown in FIG. 4C. In other words, it indicates that the inductance difference becomes largest when the circular arc length of the rotor periphery is equal to the circular arc length of the magnet.

As described above, the fact that the inductance difference is the largest indicates that an energy efficient of the brushless DC motor 1 (see FIG. 1) is the largest regarding variation in the shapes shown in FIGS. 4A, 4B, 4C, and 4D.

Further, the shapes shown in FIGS. 4A and 4B have inductance differences which are smaller than the inductance difference in the shape shown in FIG. 4C is caused by the fact that the maximum inductance is small because the circular arc length of the rotor periphery is small.

Further, the shape shown in FIG. 4D has an inductance difference which is smaller than the inductance difference in the shape shown in FIG. 4C. This is caused by the fact that though the maximum inductance is large, the minimum inductance increases because the minimum inductance becomes large, so that a width of the rotor 30 (FIG. 1 and FIGS. 4C, 4D) (in direction 102 in FIG. 3) becomes large.

As described above, in FIG. 5, the axis of abscissa represents an area of the rotor facing part. In FIGS. 4A to 4D, description is made regarding difference in shape of “circular arc lengths of the circular circumference part of the rotor peripheries 32a, 32b (the rotor 30, FIGS. 4A-4D). It is desirable that the parts of the rotor peripheries and the magnets 41a, 42a, 41b, 42b have the substantially same facing area, and facing lengths (facing length and circular arc lengths) each other.

In other words, when the facing areas and/or facing lengths (circular arc length) of the rotor peripheries and the magnets facing each other are equal to each other, the rotation torque of the brushless DC motor 1 becomes large. In addition, this increases an energy efficiency of the brushless DC motor 1, so that a high efficiency operation can be provided.

### <<Relation Between a Waist Shape in the Rotor and the Inductance Difference>>

Next, a relation between the waist shapes of the rotor and the inductance difference is described below.

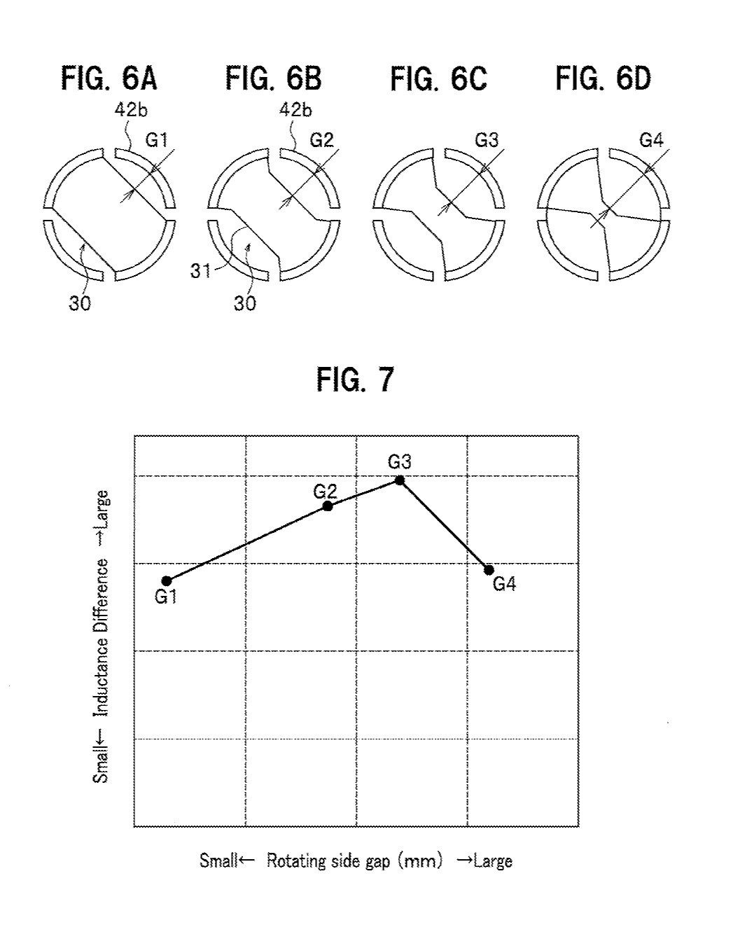

FIGS. 6A to 6D show four examples of the rotors having waist shape by decreasing a width of the rotor base 31 while the facing areas between the magnets 41a (see FIG. 1) and the rotor peripheries 32a (see FIG. 1) are equalized, i.e., a distance (gap length) between the rotor base 31 and a center of the magnet 42b is varied. FIG. 6A shows the example having the gap length G1, FIG. 6B shows the example having the gap length G2, FIG. 6C shows the example having the gap length G3, and FIG. 6D shows the example having the gap length G4.

FIG. 7 shows an example of relations of inductance differences between the maximum inductance and the minimum inductance between the rotor and the stator when a distance (gap) between the rotor base 31 and the center of the magnets 42b (see FIGS. 6A to 6D) is varied in accordance with variation in shape shown in FIGS. 6A to 6D.

In FIG. 7, the axis of abscissa represents the distance (gap) between the rotor base 31 (see FIGS. 6A to 6D) and the center of the magnet 42b (see FIGS. 6A to 6D). In FIG. 7, the distance is denoted as “rotation side surface part gap (mm)”. The axis of ordinates represents the inductance difference between the maximum inductance and the minimum inductance between the rotor and the stator. In FIG. 7, the axis of ordinates represents “inductance difference”.

In FIG. 7 characteristic points at the gap lengths G1, G2, G3, G4 correspond to the shapes shown in FIGS. 6A, 6B, 6C, 6D, respectively.

The characteristic point at the gap length G3 in FIG. 7 indicates to have a largest inductance difference. The characteristic at the gap length G3 corresponds to that when the gap length is G3.

The gap length G3 in FIG. 6C is longer than the gap length G1 in FIG. 6A, or the gap length G2 in FIG. 6B. Accordingly, the minimum inductance in the case of the gap length G3 (in the direction 102 in FIG. 3) is smaller than that in the case of the gap length G1 in FIG. 6A and that in the case of the gap length G2 in FIG. 6B. Therefore, the inductance difference when the characteristic point at the gap length G3 in FIG. 7 is larger than the inductance difference when the characteristic point at the gap length G2 or the gap length G1.

On the other hand, the minimum inductance (in the direction 102 in FIG. 3) in FIG. 6D is smaller than the minimum inductance in the case shown in FIG. 6C because the gap length G4 in FIG. 6D is longer than the gap length G3 in FIG. 6C. However, the magnetic resistance becomes high because the rotor base 31 (see FIGS. 6A to 6D) of the rotor 30 (see FIG. 6A to 6D) is too thin, which increases the magnetic resistance. This makes it hard for the magnetic flux to penetrate the rotor base 31, so that the maximum inductance becomes small (in the direction 101 in FIG. 3).

As a result, the inductance difference (the maximum inductance−the minimum inductance) in the case of the rotor shape shown in FIG. 6D is smaller than that in FIG. 6C.

This state is indicated by the relation of the inductance difference between the characteristic point at the gap lengths G4 and G3 in FIG. 7.

According to the relation in the inductance difference between the shapes shown in FIGS. 6A to 6D and the rotating side surface part in FIG. 7, it is desired that the width of the rotor base 31 (see FIGS. 6A to 6D) is made smaller within a predetermined range to increase the distance (gap length) between the rotor base 31 (see FIGS. 6A to 6D) and the center of the magnet 42b (see FIGS. 6A to 6D). In other words, it is desired that in the rotor periphery 32a, the area (or length) of a surface facing the magnets 41a, 42a, 41b, 42b (see FIG. 1) is larger than the area of a cross section in the same direction as the surface of the rotor base 31 (see FIG. 1, FIGS. 6A to 6D).

More specifically, increase in the inductance difference by decreasing the minimum inductance increases the rotation torque of the brushless DC motor 1 (FIG. 1).

Further, this enhances the energy efficiency of the brushless DC motor 1, so that a high efficiency operation is provided.

### <<Other Waist Shape of the Rotor>>

Next the other waist shapes of the rotor than the waist shape shown in FIGS. 6 to 6D are described below.

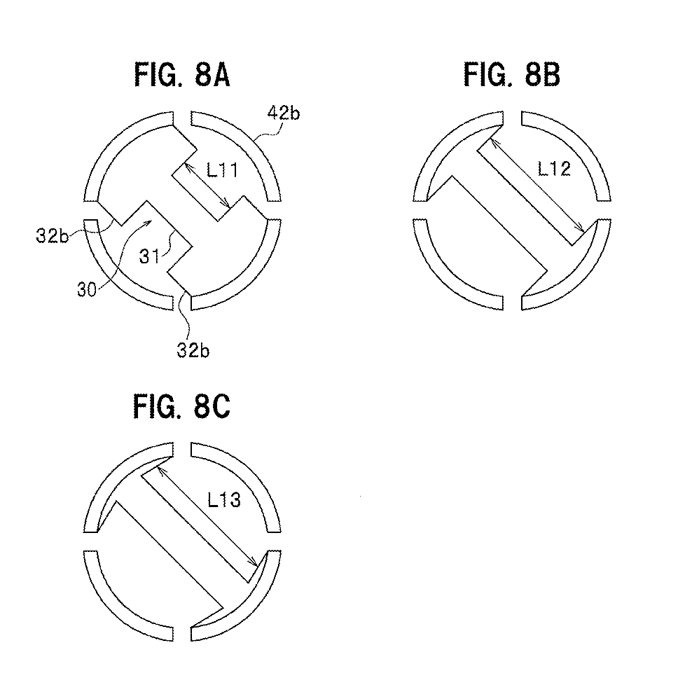

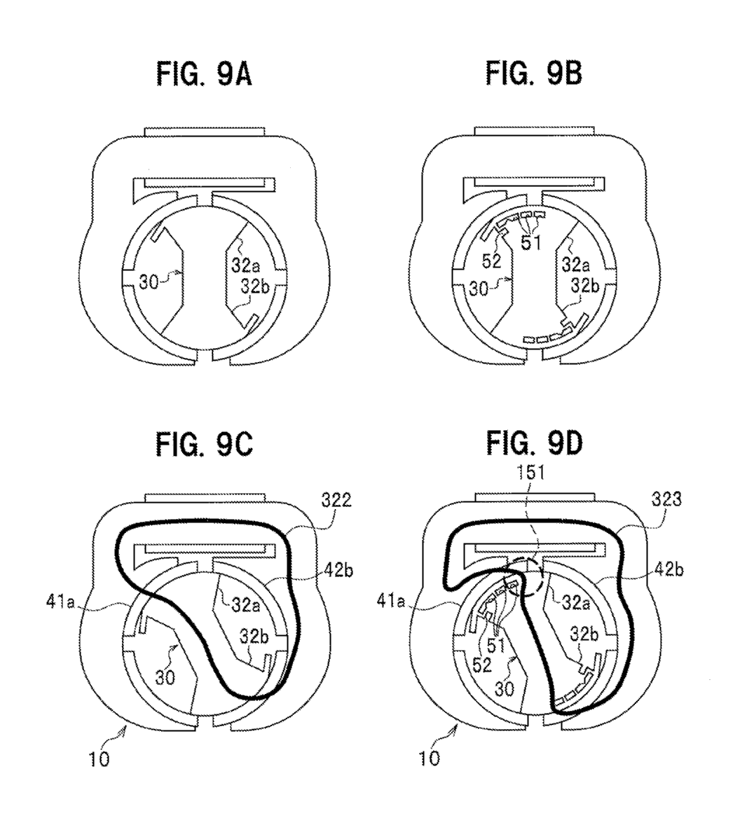

FIGS. 8A to 8C show three examples having shapes of which the distances between the two rotor peripheries 32a, 32b in the rotor 30 vary. FIG. 8A shows the distance between the two rotor peripheries 32a, 32b is L11, FIG. 8B show the distance between the two rotor peripheries 32a, 32b is L12, and FIG. 8C shows the distance between the two rotor peripheries 32a, 32b is L13.

Further in the shape of the rotor 30 shown in FIGS. 8A to 8C, the circular arc length L1 (see FIG. 1) facing the magnet 41a (see FIG. 1) is equal to the circular arc length L2 (see FIG. 1) of the magnet 41a (see FIG. 1).

Further, the distance (gap length) between the rotor base 31 and the center of the magnet 42b are equal to each other.

The shapes of the various types of the rotors shown in FIGS. 8A, 8B, 8C are provided in which the distance between the two rotor peripheries, is varied while a condition in which the circular circumference parts of the rotor peripheries and the circular arc length of the magnets are equal and the condition in which the distance between the rotor base and the center of the magnet are equal, are satisfied.

FIGS. 8A, 8B, 8C indicate that there are various shapes of the waist shapes of the rotor. However, regarding the characteristic difference due to the various types of the waist shapes of the rotor shown in FIGS. 8A, 8B, 8C because there is influence by other factors, and a detailed description is omitted.

### <<Influence and Operation by the Rotor Gap>>

Next, influence and operation of the first rotor gap 51, and the second rotor gaps 52 in the rotor peripheries 32a, 32b are described below.

FIGS. 9A to 9D illustrate the structure including the rotor gap parts (the first rotor gap 51, the second rotor gap 52). FIG. 9A shows a shape of the rotor 30 without the rotor gap parts. FIG. 9B shows a shape of the rotor 30 including a plurality of first rotor gaps 51 and the one second rotor gap 52. FIG. 9C indicates the state of a main magnetic flux 322 penetrating the rotor 30 without the rotor gap parts. FIG. 9D shows a state of a main magnetic flux 323 penetrating the rotor 30, including a plurality of first rotor gaps 51 and the one second rotor gap 52.

In FIGS. 9C and 9D, a large part of the rotor periphery 32a of the rotor 30 faces the magnet 41a, a part faces the magnet 42b.

Further, in FIGS. 9C and 9D, only the main magnetic flux is shown and representation of thin lines indicating the magnetic flux distribution of the whole is omitted. This is because of the convenience in representing and enhancement of the operation of the main magnetic flux.

In FIG. 9A, there is no gap in the rotor peripheries 32a, 32b of the rotor 30.

When there is no gaps in the rotor peripheries 32a, 32b 32a, as shown in FIG. 9C, the main magnetic flux 322 circulates drawing a gentler curve via the rotor 30 and the stator 10 (as compared with FIG. 9D).

In FIG. 9B, the rotor 30 includes at the rotor peripheries 32a, 32b the first rotor gap 51 and the second rotor gap 52 which are gaps in steel places. Further, the first rotor gap 51 comprises a plurality of gaps having a window shape formed along an outer circumferential parts of the rotor peripheries 32a, 32b (near circular circumferential part). The second rotor gap 52 comprises a gap in a notch shape formed on a side face of the rotor peripheries 32a, 32b. The “notch” may be used as a synonym of “gap”.

When a gap is formed in steel plates forming the rotor peripheries 32a, 32b, this part has a larger magnetic resistance. More specifically, the first rotor gap 51 and the second rotor gap 52 function as high magnetic resistance parts as described above. At the vicinities to the first rotor gap 51 and the second rotor gap 52, magnetic flux densities decrease because of high magnetic resistances.

Because a plurality of the first rotor gaps 51 are formed substantially on a left side of the rotor peripheries 32a, as shown in FIG. 9D, the main magnetic flux 323 makes one turn through the rotor 30 and the stator 10 as drawing a bent curve (twist of magnetic flux) bypassing the first rotor gap 51 as shown in a region 151 having a high magnetic resistance part.

Further, because the second rotor gap 52 is formed on a left side surface of the rotor peripheries 32a, 32b, this operates to prevent the magnetic flux and the main flux from transmitting thorough left sides of the rotor peripheries 32a, 32b. Further, because the second rotor gap 52 performs a function of the high magnetic resistance part, the shape of the second rotor gap 52 may be a gap having a window shape in addition to the notch in the side surface as shown in FIG. 9B, FIG. 9D, or FIG. 1.

The magnetic flux density at a bent part of the main magnetic flux 323 in the region 151 shown in FIG. 9D partially increases. A magnetic field stress (Maxwell stress) at a place having a high magnetic flux density is stronger than the magnetic field stress at a place having a low magnetic flux density such as the high magnetic resistance part. The difference in the magnetic field stress generates a torque (stress) in a counterclockwise in the rotor 30.

When the main magnetic flux 323 is liken to an elastic cord, the main magnetic flux 323 having a bent part as shown in the region 151 generates stronger torque (stress) counterclockwise because the main magnetic flux 323 tends to extend.

The counterclockwise rotation of the rotor 30 decreases the magnetic flux density of the main magnetic flux 323 at the part bent in the region 151 so that the different stresses of the magnetic fields are balanced.

On the other hand, in the case where the main magnetic flux 322 shown in FIG. 9C has the gentle curve described above, the counterclockwise rotation torque (stress) is small.

At the rotor position shown in FIG. 9C, the counterclockwise torque (stress) is small. On the other hand, when the rotor gaps (the first rotor gap 51, the second rotor gap 52) are provided, stronger counterclockwise rotation torque (stress) is generated.

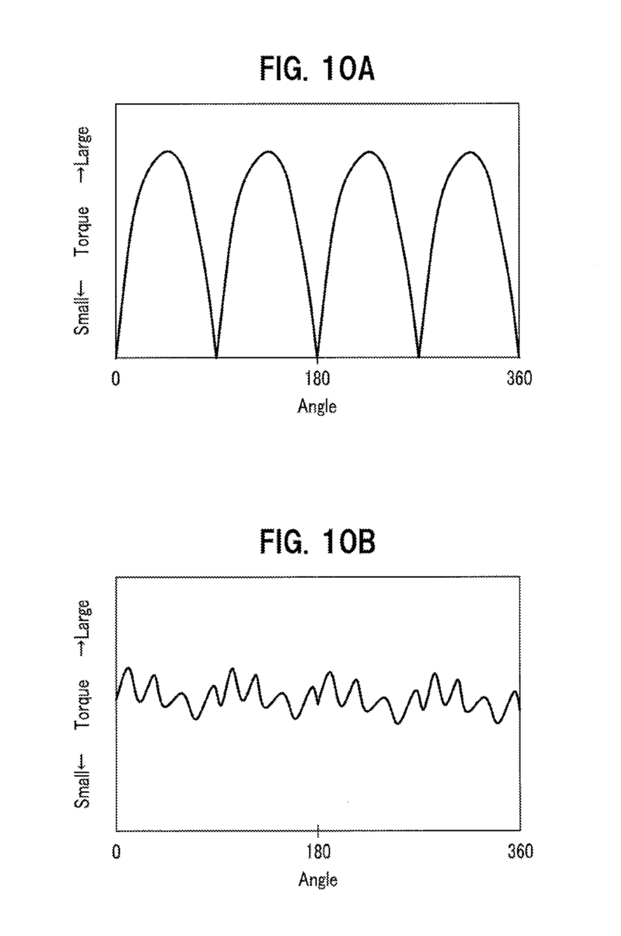

Next, influence and effect of the rotor gaps is described below with reference to FIGS. 10A and 10B.

FIG. 10A is a schematic drawing showing an example of a torque characteristic (in the case of the continuous rotation) of the brushless DC motor in the case where the rotor gaps (the first rotor gap 51 and the second rotor gap 52) at the rotor peripheries 32a, 32b in FIG. 9A are omitted.

The axis of abscissa of FIG. 10A represents an angle of rotation position of the rotor 30 and the axis of ordinate represents a torque.

A force (torque) acting a current flowing through the excitation coil 20 (see FIG. 1) becomes maximum at every 90 degree rotation and minimum at every 90 degree rotation.

Accordingly, as shown in FIG. 10A, the DC motor without the rotor gap at the rotor peripheries shows a large variation (pulsation) in torque from a minimum, i.e., substantially zero, to the maximum torque generating a large rotation force periodically, i.e., at a cycle of 90 degrees.

FIG. 10B is a schematic drawing showing an example of a torque characteristic (in the case of continuous rotation) of a brushless DC motor 1 (see FIG. 1) including the rotor gaps (the first rotor gap 51, the second rotor gap 52) at the rotor peripheries 32a, 32b shown in FIG. 9B.

The axis of abscissa in FIG. 10B represents an angle of the rotation position of the rotor 30, and the axis of ordinate represents a torque.

In FIG. 10B, the torque shows short and quick variations (pulsation) during one rotation from zero to 360 degrees. However, the variation range is extremely decreased as compared with the torque variation in FIG. 10A.

At a rotation position of the rotor 30 where the torque is originally low in FIG. 9D, a torque (stress) is strongly generated counterclockwise by the effect of the rotator gaps (the first rotor gap 51 and the second rotor gap 52), so that the difference between the maximum torque and the torque at that rotation position is decreased.

As described above, addition of the rotor gaps (the first rotor gap 51 and the second rotor gap 52) functioning as a high magnetic resistive part to the rotor peripheries 32a, 32b makes the curved portion of the magnetic flux large, which increases the rotation torque of the brushless DC motor 1 (see FIG. 1) and reduces the pulsation of the torque, so that the torque characteristic can be stabilized.

### <Influence, Operation, and Effect of the Notched Portion in the Stator>

Next, the influence, operation, and effect are described below.

### <<Operation and Effect of the First and Second Stator Notches>>

First, influence, operation, and effect of the stator notch in the first stator notch 61 and the second stator notch 62 are described below.

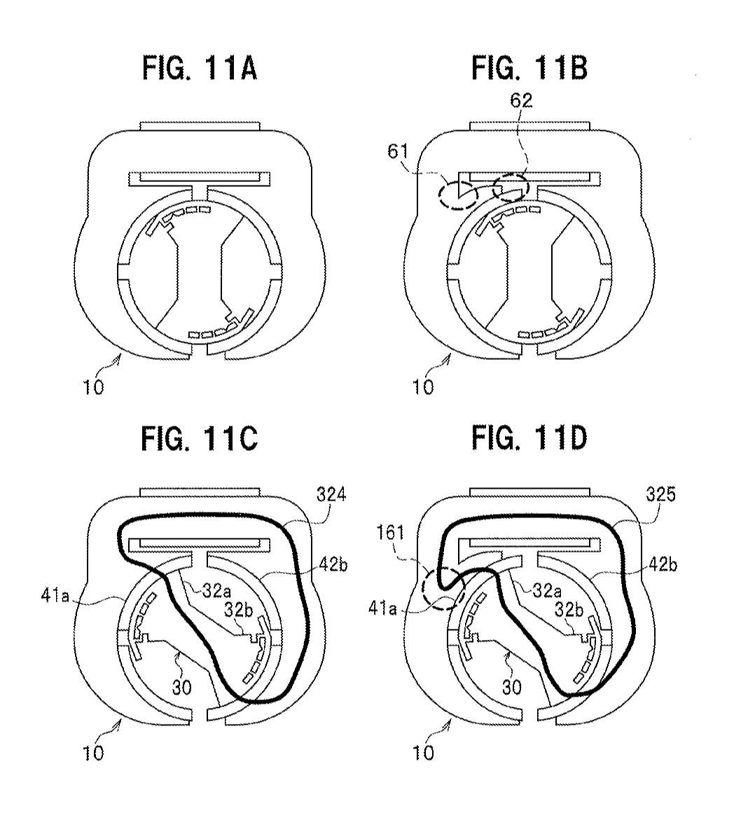

FIGS. 11A to 11D are drawings illustrating a structure including the stator notch (the first stator notch 61, the second stator notch 62) and the operation and function. FIG. 11A shows a shape of the stator 10 without the stator notch. FIG. 11B shows the stator 10 including the first stator notch 61 and the second stator notch 62. FIG. 11C shows a state that the main magnetic flux 324 transmits through the stator 10 having no notch. FIG. 11D shows a shape of a main magnetic flux 325 transmitting through the first stator notch 61 and the second stator notch 62.

FIGS. 11C and 11D show that a large part of the rotor peripheries 32a of the rotor 30 faces the magnet 41a and a remaining part faces the magnet 42b.

Further, FIGS. 9C and 9D show only the main magnetic flux and thin lines indicating magnetic flux distribution of the whole is omitted. This is because of convenience of drawing and enhancement of the operation of the main magnetic flux.

In FIG. 11A, the first housing member 12 (see FIG. 1) near the excitation coil 20 (see FIG. 1) of the stator 10 is in a symmetric shape without the notch.

In the case where there is no gap in the first housing member (12: FIG. 1) near the excitation coil 20 (see FIG. 1), a main magnetic flux 324 makes one turn with a more gentle curve than that on, for example, FIG. 11D through the rotor 30 and the stator 10.

In FIG. 11B, the first stator notch 61 is provided as a notch in steel plates at the first housing member 12 (see FIG. 1) near a left end of the excitation coil 20 (see FIG. 1) of the stator 10. Further, there is the second stator notch 62 at the first housing member 12 (see FIG. 1) near the center of the excitation coil 20 (see FIG. 1) of the stator 10.

The first stator notch 61 and the second stator notch 62, being notches in steel plates, operate as high magnetic resistive members where magnetic resistance increases there, which makes it not easy for the magnetic flux to flow there.

Because the first stator notch 61 and the second stator notch 62 are provided having high magnetic resistances, the main magnetic flux 325 bypasses the first stator notch 61 and makes one turn through the rotor 30 and the stator 10 drawing a bent and curved line (magnetic flux curve) as shown in FIG. 11D.

A curved part of the main magnetic flux 325 in a region 161 has a magnetic field locally increased, so that a torque (stress) is generated stronger to make movement in counterclockwise rotation direction to decrease the magnetic flux density.

In a case where the main magnetic flux 324 in FIG. 11C draws the gentle curve as described above, there is no part corresponding to the magnetic flux density of the main magnetic flux 325 in the region 161 shown in FIG. 11D, so that the torque (stress) in the clockwise rotation is small.

More specifically, at the same rotor position in FIG. 11C and FIG. 11D, the torque (stress) in counterclockwise rotation is low. On the other hand, the stator notches (the first stator notch 61, the second stator notch 62) shown in FIG. 11B are provided. This generates a relatively stronger counterclockwise torque (stress).

Regarding the generation of the torque in the counterclockwise torque, the first stator notch 61 is more effective than the second stator notch 62.

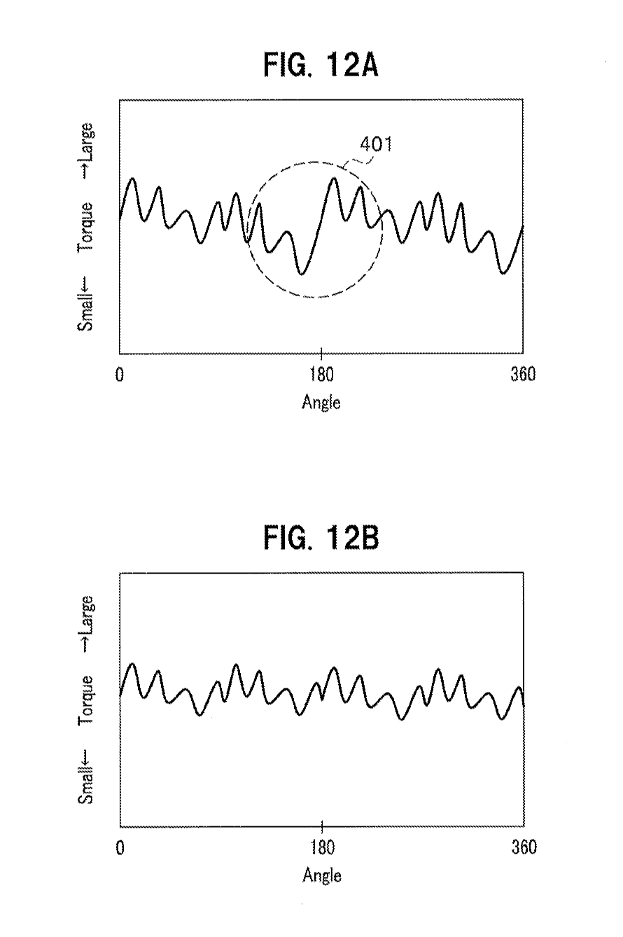

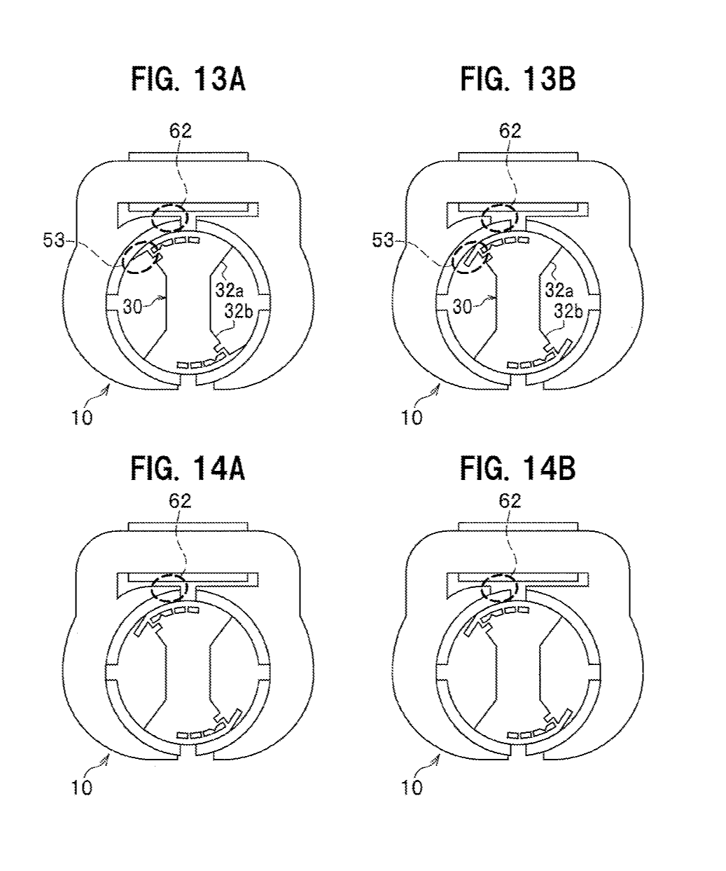

Next, with reference to FIGS. 12A and 12B, operations of the stator notch (the first stator notch 61, the second stator notch 62) are described below.

FIG. 12A is a drawing showing an example of torque characteristic (in a case of continuous operation) of the brushless DC motor 1 (see FIG. 1) in which the stator notches (the first stator notch 61, the second stator notch 62) are omitted.

The axis of abscissa in FIG. 12A represents an angle of the rotation position of the rotor 30, and the axis of ordinate represent a torque.

As shown in FIG. 12A, in the brushless DC motor without the stator notch (the first stator notch 61, the second stator notch 62), the torque relatively largely varies (for example, as compared with FIG. 12B) in accordance with the angle of the rotor 30. Particularly, in a region 401 indicated with a broken line in FIG. 12A, a torque variation (pulsation) is large.

FIG. 12B is a drawing showing an example of a torque characteristic (in the case of continuous operation) of the brushless DC motor 1 (see FIG. 1) in which the stator notch (the first stator notch 61, the second stator notch 62) are provided.

The axis of abscissa in FIG. 12B represents the angle of the rotation position of the rotor 30, and the axis of ordinate represents the torque.

In FIG. 12B, the torque fluctuates (pulsation) in one rotation from 0 degree to 360 degrees. However, a variation range is reduced in comparison with the variation in FIG. 12A. Particularly, the torque variation (pulsation) is largely reduced at the place (region) in FIG. 12B corresponding to the region 401 in FIG. 12A.

The reduction in the torque variation (pulsation) is caused by the fact that there is not so large difference from the maximum torque because the torque (stress) is strongly generated in the counterclockwise rotation direction by the operation of the stator notches (the first stator notch 61, the second stator notch 62) at the position of the rotor 30 shown in FIG. 11D where the torque is originally low.

As described above, the stator 10 includes notches in the steel plate at the first housing member 12 (see FIG. 1) in the vicinity of the left end and middle of the excitation coil 20 (see FIG. 1). This increases deformation of the magnetic flux loop, which increases the rotation torque of the brushless DC motor 1 as well as suppresses pulsation of torque. This provides an advantageous effect to stabilize the torque characteristic.

### <<Operation and Effect of Shapes of Extending Part and Second Stator Notch>>

Next, operation and effect of shapes of extending part and second stator notch are described below.

FIGS. 13A and 13B are drawings for explaining influence, operation and effect caused by the shape of the extending part 53 and the presence and absence of the second stator notch 62. FIG. 13A shows a shape of the extending part 53 extending facing the inner circumferential part of the magnet as similar to the rotor periphery 32a and no notch in the steel plates in the second stator notch 62 (corresponding to the second stator notch 62). FIG. 13B shows the shape of the extending part 53 in which the extending part 53 gradually separating from the circumferential part inside the magnet as going to a tip and the second stator notch 62 is present.

The extending part 53 contributes to the counterclockwise operation of the rotor 30. The torque characteristic varies in accordance with the shape and arrangement. The difference in the extending part 53 between FIG. 13A and FIG. 13B is as follows:

The extending part 53 in FIG. 13A is arranged in parallel to the arc portion of the inside of the magnet 41a (see FIG. 1) to face the arc portion. On the other hand, the extending part 53 in FIG. 13B has such a shape that the extending part 53 more separates from the inner side of the arc part of the magnet 41a as going to the tip thereof.

In FIG. 13B, the second stator notch 62 is provided in association with the shape that the extending part 53 becomes remote from the arc portion of the magnet. The second stator notch 62 is provided, so that stability in torque is further increased as described later. In FIG. 13A, the second stator notch 62 is not provided.

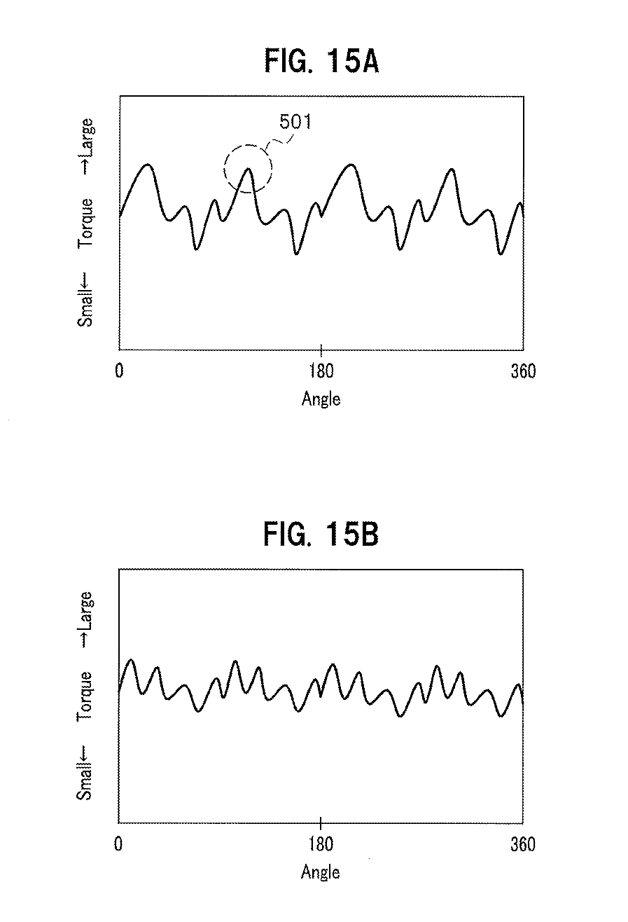

Next, with reference to FIGS. 15A and 15B influence on the torque variation and operation depending on the shape of the extending part 53 and the presence and absence of the second stator notch 62 are described below (description regarding FIG. 14 will be described later)

FIG. 15A is a chart of an example of the torque characteristic of the brushless DC motor 1 (see FIG. 1) in the case where the extending part 53 has a shape of the extending part facing the arc part of the magnet.

An axis of abscissa in FIG. 15A represents an angle of the rotation position of the rotor 30, and the axis of the ordinate represents the torque of the rotor 30.

As shown in FIG. 15A, the torque relatively largely varies in accordance with the angle of the rotor 30 (for example, as compared with FIG. 15B) in the case where the extending part 53 has such a shape that the extending part 53 faces the arc part inside the magnet similar to the circumferential part of the rotor peripheries 32a, and there is no notch in the region of the second stator notch 62 of the first housing member 12 (see FIG. 1) near the center of the excitation coil 20 (see FIG. 1). Particularly, in a region 501 indicated with a broken line in FIG. 15A, there is a large torque variation.

FIG. 15B is a chart showing an example of the torque characteristic (in the case of continuous operation) of the brushless DC motor 1 (see FIG. 1) in the case where the shape of the extending part 53 in which the extending part 53 gradually separating from the circumferential part inside the magnet as going to a tip and the second stator notch 62 is present.

An axis of abscissa in FIG. 15B represents the angle of the rotation position of the rotor 30, and the axis of the ordinate represents the torque of the rotor 30.

In FIG. 15B, the torque fluctuates in one rotation from 0 degree to 360 degrees. However, a variation range is reduced in comparison with the variation in FIG. 15A. Particularly, the torque variation is largely reduced at the place (region) in FIG. 15B corresponding to the region 501 in FIG. 15A.

The reduction in the torque variation (pulsation) is caused by suppression of rapid variation in the torque occurring when the extending part 53 approaches the magnet where the extending part 53 next locates while the rotor 30 rotates because the extending part 53 has such a shape that the extending part 53 more separates from the arc part inside of the magnet as going to the tip thereof.

### <<Influence and Operation of Second Stator Notch>>

Next influence by and operation of the second stator notch 62 are described below.

As described above, with reference to FIGS. 13A, 13B, 15A, and 15B, the influence of the extending part and the second stator notch 53 have been described. Influence of the second stator notch 62 is further described below.

FIGS. 14A and 14B are drawings illustrating influence and operation on torque variations depending on the presence and absence of the second stator notch. FIG. 14A shows a shape in the case of no second stator notch in the region (corresponding to the second stator notches) 62. FIG. 14B shows a shape in the case where there is the second stator notch 62.

The difference between FIG. 14B and FIG. 14A is in the presence and the absence of the second stator notch 62. An advantageous effect of the second stator notch 62 is described through comparing the torque characteristics with difference in the presence and the absence of the second stator notch 62.

In FIGS. 14A and 14B, the extending part 53 (see FIG. 13) has such the shape that the extending part 53 more separates from the arc part of the inner side of the magnet 41a as going to the tip thereof.

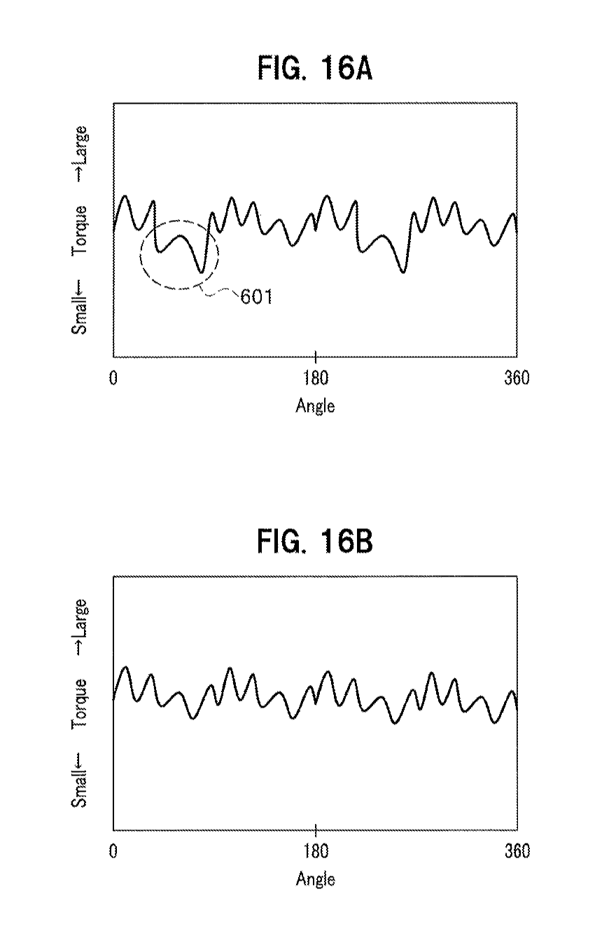

Next, with reference to FIGS. 16A and 16B influence on the torque variation and operation depending on the presence and absence of the second stator notch 62.

FIG. 16A is a chart of an example of the torque characteristic of the brushless DC motor 1 (see FIG. 1) in the absence of the second stator notch 62 shown in FIG. 14A.

The axis of abscissa in FIG. 16A represents the angle of the rotation position of the rotor 30, and the axis of ordinate represents the torque of the rotor 30.

As shown in FIG. 16A, the torque relatively largely varies (pulsate) in accordance with the angle of the rotor 30 (for example, as compared with FIG. 15B) in the case of no notch in the region of the second stator notch 62. Particularly, in a region 601 indicated with a broken line in FIG. 16A, there is a large torque variation (pulsation).

FIG. 16B is a chart illustrating an example of a torque characteristic of the brushless DC motor in the case that there is the second stator notch 62 shown in FIG. 14B.

The axis of abscissa in FIG. 16B represents the angle of the rotation position of the rotor 30, and the axis of ordinate represents the torque of the rotor 30.

In FIG. 16B, the torque shortly fluctuates (pulsation) during one turn, i.e., 0 to 360 degrees. However, a range of fluctuation is reduced as compared with the torque variation in FIG. 16A. Particularly, in a region corresponding to the region 601 in FIG. 15A, the torque variation (pulsation) is largely reduced.

The reduction in the torque variation (pulsation is caused by suppression the rapid variation in torque during rotation of the 30 because the second stator notch 62 is added.

### Second Embodiment

### Structure of Brushless DC Motor

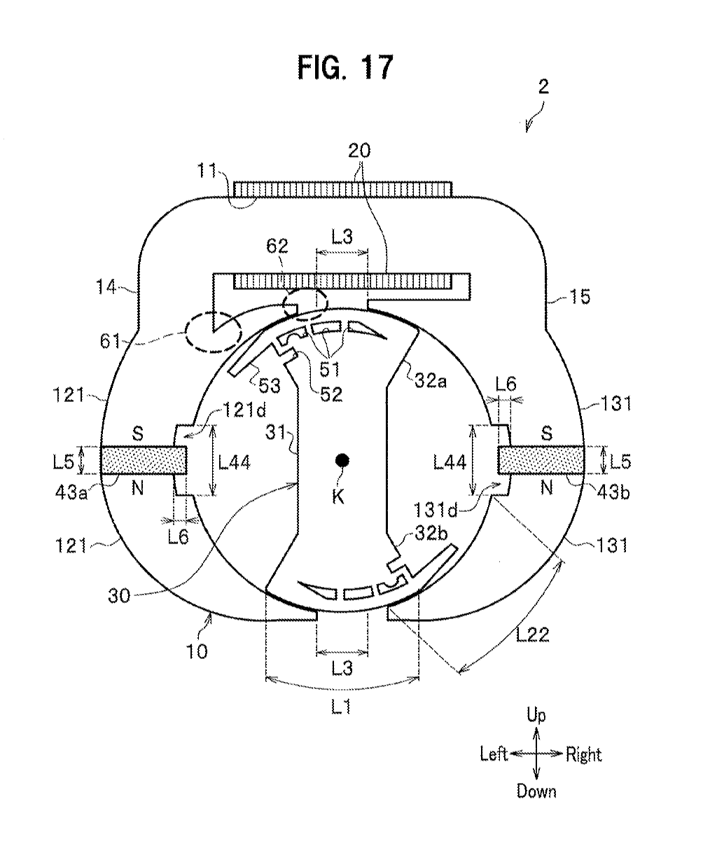

FIG. 17 is a cross-sectional drawing taken along a direction having a right angle with the rotation shaft of the brushless DC motor 2 according to the second embodiment of the present invention.

In FIG. 17, a brushless DC motor 2 has the inner rotor type structure in which a rotor 30 is housed in a stator 10, and the rotor 30 is rotatably supported through the rotation shaft K inside the stator 10 (inside in a diametrical direction regarding a rotation shaft K). The rotation shaft K is connected to a load (not shown).

The brushless DC motor 2 includes the stator 10 around which an excitation coil 20 is wound, the rotor 30 being rotatable counterclockwise and housed in the stator 10, and two magnets 43a, 43b fixed in the stator 10.

The magnets 41a, 43a form a pair facing with each other across the rotation shaft K.

With the structure described above, the brushless DC motor 2 has a function to generate a torque for counterclockwise rotation drive of the rotor 30 using synthesized magnetic flux of the magnetic flux according to a current flowing through the excitation coil 20 and magnetic flux generated by the four magnets 41a, 42a, 41b, 42b fixed on the internal circumferential surface of the stator 10. Operation will be described later.

### <<Stator>>

The stator 10 comprises a magnetic substance (for example, silicon steel plates) for housing the rotor 30 inside in the diametrical direction, and includes a coil winding member 11, a first housing member 121, a second housing member 131, a first yoke 14, and a second yoke 15.

The coil winding member 11 comprises a bar like member extending in a left-right direction around which the excitation coil 20 is wound.

The first housing member 121 has a substantially C-shape in cross-sectional view and extends in parallel to the rotation shaft K (in face side-deep side direction of paper). The first housing member 121 is connected to the left end of the coil winding member 11 through the first yoke 14.

The second housing member 131 has a substantially inverted C-shape in cross-sectional view and extends in parallel to the rotation shaft K. The second housing member 131 is connected to the right end of the coil winding member 11 through the second yoke 15.

More specifically, the first housing member 121 and the second housing member 131 formed integrally with the coil winding member 11 through the first yoke 14 and the second yoke 15 form a housing space in a circular cylindrical column with a center at the rotation shaft K such that the rotor 30 is interposed between the first housing member 121 and the second housing member 131 from the left side and the right side.

Further, the first housing member 121 is formed to have a thickness decreasing as going to the upper and lower ends. This limits amounts of the magnetic flux passing through part near the upper end and the lower end to the first housing member 121. This is true for the second housing member 131.

The up-down direction and the left-right direction are shown in FIG. 17 also.

Further, an upper end of the first housing member 121 and the upper end of the second housing member 131 are spaced in the left-right direction by a sum of a distance (interval) L3 and a length in the left-right direction of the second notch 62.

Similarly, a low end of the first housing member 121 and the lower end of the second housing member 131 are spaced in the left-right direction by a sum of a distance (interval) L3 and the length in the left-right direction of the second stator notch 62.

These gaps cause magnetic flux generated by the current in the excitation coil 20 necessarily to pass through the rotor 30. In other words, the magnetic flux generated by the current flowing through the excitation coil 20 is caused not to close only within the stator 10.

Formed between upper and lower first housing members 121 is a step 121d.

Formed between upper and lower second housing members 131 is a step 131d.

Steps 12d, 13d have a distance (interval) of L44 in vertical directions.

In the step 121d, 131d, provision of a gap having the distance (interval) L44 can reduce torque pulsations of the rotor 30. Further, provision of the gap having a distance (interval) L44 can increase a width of the stator on which the magnets 43a, 43b act.

A distance (interval) L3 between upper ends of the first housing member 121 and a second housing member 131 and between lower ends of the first housing member 121 and the second housing member 131 is substantially the same as the distance (interval) L44 in the vertical direction between the steps 121d of the vertically arranged first housing members 121 and between steps 131d of the vertically arranged the second housing members 131.

Near the lower side of a left end of the bar wound by the excitation coil 20, there are the first stator notch 61 and the second stator notch 62 as parts where the magnetic substance of the first housing member 121 is partially cut out.

The first stator notch 61 and the second stator notch 62 serve as high magnetic resistors of which magnetic resistors are high. The first stator notch 61 and the second stator notch 62 reduce torque pulsation generated during rotation of the rotor 30.

The magnets 43a, 43b are permanent magnets having rectangular parallelepiped shapes, respectively.

The magnet 43a is fixed between the vertically arranged the first housing members 121 of the stator 10.

The magnet 43b is fixed between the vertically arranged the second housing members 131 of the stator 10.

The magnets 43a, 43b have S poles on upper sides thereof and N poles on the lower sides thereof.

The magnet 43a, 43b have a thickness L5 in the vertical direction.

The magnet 43a protrudes from the first housing member 121 by a distance (interval) L6 in the steps 121d of the vertically arranged first housing members 121 and is exposed to the housing space.

A magnet 43b protrudes from the first housing member 121 by a distance (interval) L6 between the steps 131d of the vertically arranged second housing members 131 and being exposed.

In the structure in FIG. 17, the magnets 43a, 43a are face each other across the rotation shaft K of the rotor 30 as a center. As described above, the magnets 43a 43b have the S poles on the upper sides thereof and the N poles on the lower sides thereof. Directions of the magnetic fields generated by the magnetic poles are orthogonal with the direction between the magnets 43a, 43b. Further, directions of the magnetic fields generated by the magnets 43a, 43b are the same because the both magnets 43a, 43a have the S poles on the upper sides thereof.

Further, as described above, the magnets 43a, 43b have rectangular parallelepiped shapes as described above. Widths in directions along contacts between the magnets 43a, 43b and the first housing member 121 and the second housing members 131, respectively (hereinafter also referred to as lateral widths) are longer than the thickness L5 of the magnets 43a, 43b.

The magnets 43a, 43b are Neodymium magnets produced by sintering main components including Neodymium of rare earth, iron, and boron. Materials of the Neodymium magnet are expensive and difficult to be processed. Accordingly, these materials are hard, and thus difficult to be processed by monolithic molding.

Formation of the magnets 43a, 43b with the expensive material in a rectangular parallelepiped to have a lateral width which is longer than the thickness L5, which generates larger magnetic field with the same volume. In other words, this provides an advantageous effect in a magnetic force intensity and in production process. Comparison with the first embodiment (the magnet is formed in a circular arc cross-sectional shape), using no rectangular parallelepiped shape will be described later and an advantageous effect in forming the magnet in the rectangular parallelepiped will be described again.

### <<Rotor>>

The rotor 30 in the second embodiment has the same components and structure as the rotor 30 in the second embodiment (see FIG. 17), and a duplicated explanation is omitted.

The arc length (arc length) L1 of the arc shapes of the rotor peripheries 32a, 32b according to the second embodiment in FIG. 17 is generally equal to the arc length (arc length) L22 of the rotor peripheries 32a, 32b. The feature of L1=L22 is desired from point view of a high efficiency operation of the brushless DC motor 2.

### <Rotating Operation Principles>

Next rotating operation principle of the brushless DC motor 2 is described below.

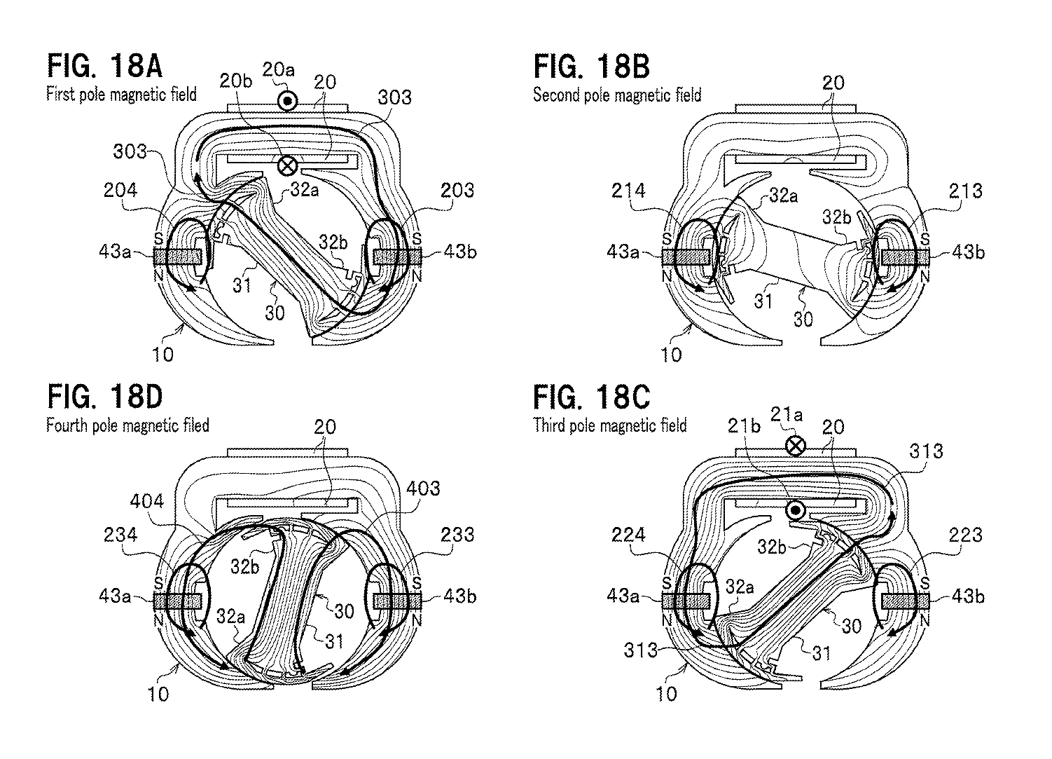

FIGS. 18A to 18D are drawings illustrating a rotating operation of the brushless DC motor 2 according to the second embodiment of the present invention. FIG. 18A shows a position of the rotor and the main magnetic flux of the stator at a first stable point (at first pole). FIG. 18B shows a position of the rotor at a second stable point (at second poles) and the main magnetic flux of the rotor and the stator at a second stable point (at second pole). FIG. 18C shows a position of the rotor when a current is allowed in a second direction in the exciting coil and the main magnetic flux of the rotor and the stator at a third stable point (at third pole). FIG. 18D shows a position of the rotor and the main magnetic flux of the stator at a fourth stable point (fourth pole).

In FIGS. 18A, 18B, 18C, and 18D, a magnetic field distribution by the rotor 30 and the stator 10 is generally shown regarding the rotor 30 and the excitation coil 20 with a plurality of thin lines. Further, magnetic flux leakage which does not contribute to rotation of the rotor 30 is omitted. Because it may be difficult to understand the operation with the thin lines indicating the magnetic distribution, a synthesized magnetic flux from the magnetic flux distribution is also shown.

As the main magnetic flux, the main magnetic flux of which loops are closed through the magnet 43a and the stator 10 are shown with thick lines as a main magnetic flux 204, a main magnetic field flux 214, a main magnetic field flux 224, and a main magnetic field flux 234.

The main magnetic flux of which loops are closed through the magnet 43b and the stator 10 are shown with thick lines as a main magnetic flux 203, a main magnetic field flux 213, a main magnetic field flux 233, and a main magnetic field flux 234.

The main magnetic flux of which loops are closed through the excitation coil 20, the stator 10, and the rotor 30 are shown with thick lines as a main magnetic flux 303, and a main magnetic field flux 313.

The main magnetic flux of which loops are closed through the stator 10 and the rotor 30 are shown with thick lines as a main magnetic flux 404, and a main magnetic field flux 403.

As described above, the magnets 43a, 43b have S poles on the upper side thereof and N poles on the lower side thereof.

Current flowing through the excitation coil 20 in the first direction and current flowing through the excitation coil 20 in the second direction which are combined with the magnets 43a, 43a, which generates magnetic fields at four poles corresponding to that the rotor 30 has the first to fourth stable point.

In FIG. 18A, a current flows in the excitation coil 20 in a first direction. Accordingly, a main magnetic flux 303 is formed to pass through the excitation coil 20, the stator 10, and the rotor 30. Further, the main magnetic flux 204 is formed in a closed loop by the magnet 43a through the stator 10, and a main magnetic flux 203 is formed in a closed loop by the magnet 43b through the stator 10.

At this instance, in the rotor 30, torque balance is formed in which a clockwise rotation force (torque) by the magnetic field (main magnetic flux) by the excitation coil 20 and a counterclockwise rotation force (torque) by the magnetic field (main magnetic flux) by the magnets 43a, 43b, are balanced, so that a first stable point (first pole) where the rotor does not rotate is provided. After that, when the current flowing through the excitation coil 20 in the first direction is turned off, the balance is broken, so that the rotor starts rotating counterclockwise because ends of the rotor are pulled by the magnetic fields (main flux) generated by the magnets 43a, 43b.

The extending parts 53 (see FIG. 17) installed at a left end on a circumferential side of the rotor peripheries 32a, 32b more efficiently operate regarding the counterclockwise rotation.

### <<Second Stable Point (Second Pole)>>

FIG. 18B shows a position of the rotor 30 at a second stable point (second pole) and main magnetic flux 213, 214 as described above.

In FIG. 18B, no current flows through the excitation coil 20. Accordingly the rotor 30 is pulled by magnetic forces generated by the magnets 43a, 43b.

In other words, the rotor periphery 32a overlaps with the magnet 43a in the diametrical direction. This makes magnetic connection between the rotor periphery 32a and the magnet 43a, so that the main magnetic flux 214 is formed.

Further, the rotor periphery 32b overlaps with the magnet 43b in the diametrical direction. This makes magnetic connection between the rotor periphery 32b and the magnet 43b, so that the main magnetic flux 213 is formed.

Formation of the main magnetic flux 214 and the main magnetic flux 213 makes a torque balance in FIG. 18B.

After this, when the current flows through the excitation coil 20 in the second direction, the torque balance is broken and the end of the rotor periphery 32a is pulled by the magnetic field (main magnetic flux) generated by the excitation coil 20.

### <<Third Stable Point (Third Pole)>>

FIG. 18C shows a state in which the rotor is at the third stable point (third pole) when the current is allowed to flow in the second direction through the exciting coil 20.

The current flow in the excitation coil 20 in the second direction form a new magnetic flux 313 is formed through the stator 10, the magnet 43a, and the rotor 30.

The magnetic flux 313 generated by the current flowing through the excitation coil 20, the main magnetic flux 224, 223 make a torque balance in the rotor 30.

After this, when the current flowing through the excitation coil 20 in the second direction is cut out, the torque balance is broken, so that the rotor 30 starts movement counterclockwise because of pulling by the magnetic field (magnetic flux) generated by the magnets 43a, 43b.

### <<Forth Stable Point (Fourth Pole)>>

FIG. 18D shows a position of the rotor 30 and the main magnetic flux of a stator at a fourth stable point (fourth pole).

In FIG. 18D, no current flows through the excitation coil 20. Accordingly, a torque balance is made by the magnetic forces generated by the magnets 43a, 43b in the rotor 30.

More specifically, in the state shown in FIG. 18D, a torque balance is made between counterclockwise rotation force and clockwise rotation force of the rotor 30 by a main magnetic flux 404 and a main magnetic flux 403.

After this, when the current flows through the excitation coil 20 in the first direction, the torque balance at the fourth stable point (fourth pole) is broken, so that the rotor 30 starts moving in the counterclockwise direction.

### <<At the First Stable Point (First Pole) Again>>

When the current flows through the excitation coil 20, the state returns to the stage shown in FIG. 18A. The rotor 30 rotates by 180 degrees from the initial position. In order that the rotor 30 returns to the original state (360 degrees), operations shown in FIG. 18A to 18D are to be done.

However, because the shape of the rotor is point-symmetrical about the rotation shaft K, the rotor 30 rotates to a stable points distance by 180 degrees, there is no visual difference. Accordingly, a substantially duplicated explanation is omitted.

As described above, by allowing the current to flow through the excitation coil 20 alternately, the brushless DC motor 2 rotates clockwise in the order of FIGS. 18A, 18B, 18C, 18D, and 18A.

Further, the control of the excitation coil 20 is made step by step to make stop at each of the stable points, or alternation of the current in the excitation coil 20 is made continuously, so that a continuous counter clock width direction.

### <Supplemental Explanation Regarding the Form and Structure of the Magnet in the Second Embodiment>

Next, forms and structure in the second embodiment is additionally described below. This is because to explain a shape and a structure of the magnet according to a third embodiment, the shape and structure of the magnets according to the second embodiment are more specifically explained for comparison.

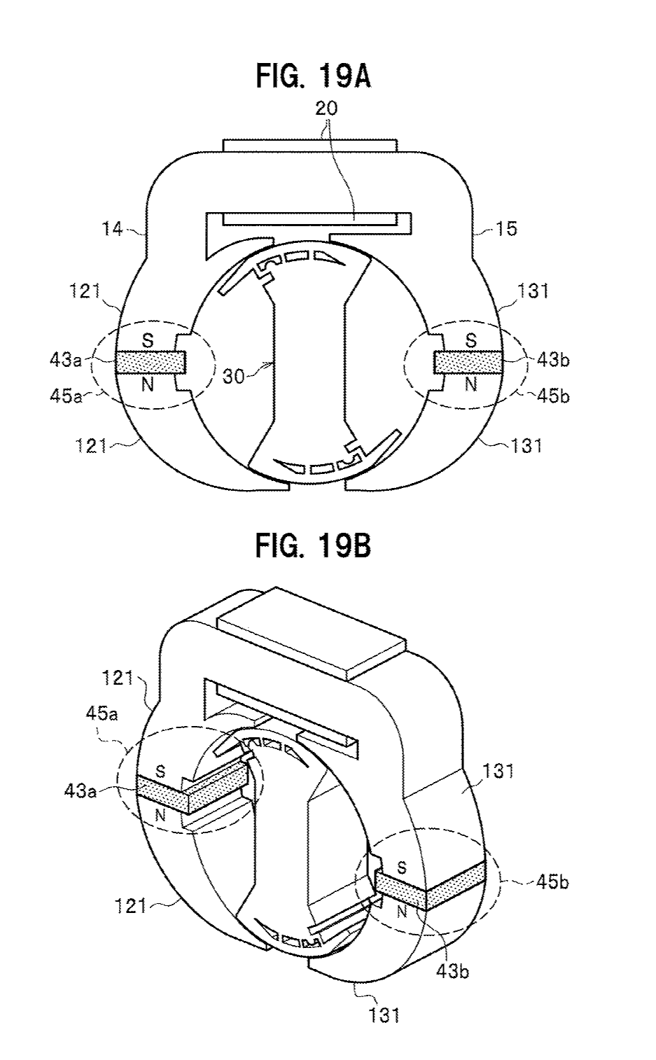

FIGS. 19A and 19B are cross-sectional diagrams more specifically illustrating shapes of the magnets for the brushless DC motor according to the second embodiment. FIG. 19A is drawn to remarkably show the vicinity of the magnets shown in FIG. 17 and FIG. 19B is a perspective view to more intelligibly show the shape of the magnets.

In regions 45a and 45b showing the vicinity of the magnets 43a, 43b, the magnets 43a, 43b protrude from the steps 121d, 131d (see FIG. 17) by a distance (interval) L6 and are exposed from the first housing member 121 and the second housing member 131. In other words, at the steps 121d, 131d, ends of the magnets 43a, 43b protrude from ends of the stator 10 at the steps 121d, 131d.

The parts of the magnets 43a, 43b exposed from the first housing member 121 and the second housing member 131 contact with high magnetic resistances. This decreases magnetic flux (magnetic field) transmitting through side faces of the magnets 43a, 43b (the steps 121d, 131d), and increases magnetic flux (magnetic fields) transmitting through the first housing members 121, 131, so that the magnetic forces by the magnets 43a, 43b are efficiently used with increase in efficiency. This provides the brushless DC motor capable of a high efficient operation.

### Third Embodiment

Next, a brushless DC motor according to a third embodiment is described below.

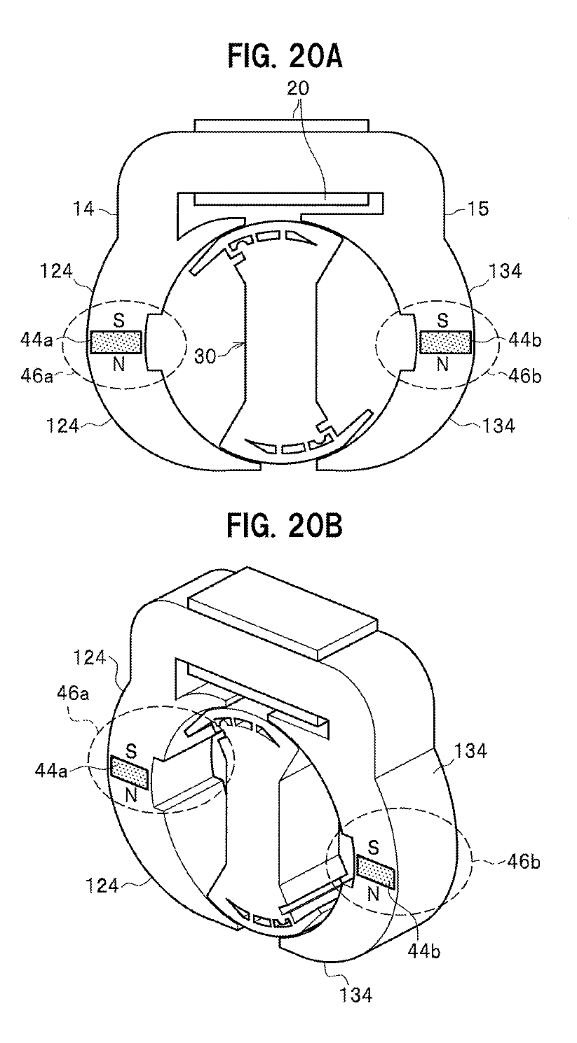

FIGS. 20A and 20B are drawings showing the structure of the brushless DC motor according to the third embodiment of the present invention. FIG. 20A is a cross-sectional diagram. FIG. 20B is a perspective view including the cross-section shown in FIG. 20A.

As shown in FIGS. 20A, 20B, in the third embodiment, focusing on regions 46a, 46b, magnets 44a, 44b are buried in a first housing member 124 and a second housing member 134. In other words, in the steps 121d, 131d, the ends of the magnets 44a, 44b are buried inside end surface of the stator 10 at the steps 121d, 131d.

Accordingly, producing the first housing member 124 and the second housing member 134 is not separated between the upper and lower parts of the first housing member 124 and the second housing member 134 and can be made in one process. This provides advantageous effects of a easy process at a low cost.

Further there is an advantageous effect in that the first housing member 124 and the second housing member 134 have higher stiffness because of using the same steel plates though the magnets 44a, 44b are buried.

Further, a width of the magnets 44a, 44b are made shorter than the width of the stator. This eliminates the necessity of bonging the magnet with adhesive, so that it becomes easy to fix the magnet to the stator. This provides an advantageous effect in that the manufacturing process is made easier.

### Fourth Embodiment

Next, a brushless DC motor according to a fourth embodiment of the present invention is described below.

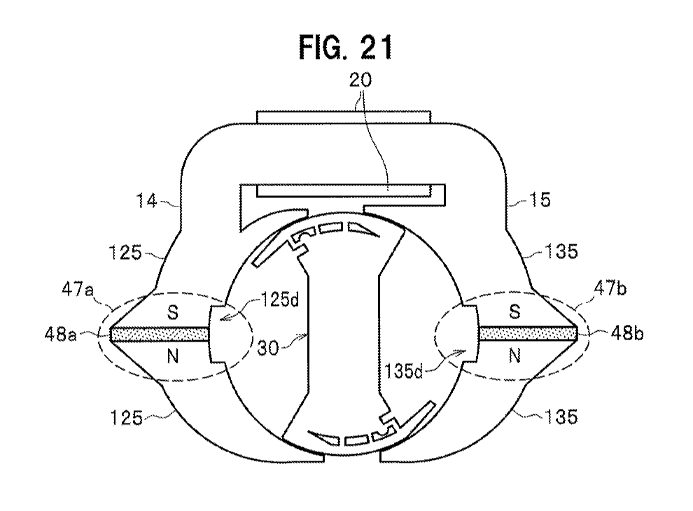

FIG. 21 is a cross-sectional diagram of the brushless DC motor according to a fourth embodiment of the present invention.

FIG. 21 showing the cross-sectional structure according to the fourth embodiment is compared with FIG. 17 or FIG. 19A showing the cross-sectional structure according to the second embodiment. There is a difference from the brushless DC motor according to the second embodiment in structures in regions 47a, 47b which show the vicinity of magnets 48a, 48b from the brushless DC motor according to the second embodiment.

More specifically, in FIG. 21, a width of parts where the magnets 48a, 48b contact with a first housing member 125 and a second housing member 135 in the cross section (appropriately also referred to as “lateral width”) is longer than a width of parts where the magnets 43a, 43b contact with a first housing member 121 and a second housing member 131 in the cross section shown in FIG. 19.

Further, corresponding to this, a width of a first housing member 125 and a second housing member 135 contact with the magnets 48a, 48b is made longer.

In other words, in the brushless DC motor according to the fourth embodiment, the lateral widths of the magnets 48a, 48b are made longer within an allowable range as the brushless DC motor in consideration of the structure. The longer lateral width of the magnets 48a, 48b strengthens the magnetic force (magnetic field) of the magnets 48a, 48b.

An end of the magnet 48a is flush with the bottom surfaces (wall surface on the side of the magnet 48a) of a step 125d between the upper and lower first housing members 125 without protrusion outside the stator.

An end of the magnet 48b is flush with the bottom surface (wall surface on the side of the magnet 48b) of a step 135d between the upper and lower second housing members 135 without protrusion outside the stator.

As described above, because the end of the magnet 48a is flush with the bottom surface of a step 135d, the magnetic field generated by the magnet 48a can act on the stator without loss.

As described above, the magnetic force (magnetic fields) of the magnets 48a, 48b according to the fourth embodiment act on the rotor stronger than the case of the magnets 43a, 43a according to the second embodiment by a difference in the width (lateral width) of parts where the magnets 48a, 48b according to the fourth embodiment contact with a first housing member 125 and the second housing member 135. This enhances the efficiency to generate the torque, so that the brushless DC motor with a high efficient operation can be provided.

### <Advantageous Effect of the First to Fourth Embodiments Against Prior Art Such as the Patent Document 1>

Advantageous effect of the first to fourth embodiments against prior art such as the Patent Document 1 are as follows:

<A> The brushless DC motors according to the first to fourth embodiments eliminates the necessity of the rotation angle sensor such as a Resolvers which were used in the prior art. In other words, according to the first to fourth embodiments, the position sensor, a position sensor I/O circuit, and a position sensor mounting parts can be omitted. This can decrease the production cost remarkably.
<B> According to the first to fourth embodiments, an auxiliary coil (shading coil) for rotation start is unnecessary, so that a negative torque is not generated. This provides a higher operation efficiency.

### <Comparison Between the Second to Fourth Embodiments and the First Embodiment>

Next, the second to fourth embodiments are compared with the first embodiment.

The brushless DC motors according to the second to fourth embodiments use two magnets having rectangular parallelepiped shape. The brushless DC motor according to the first embodiment uses four circular arc shape magnets.

As described above, as the magnet, Neodymium magnets are generally used in the brushless DC motor, the Neodymium magnet being produced by stinting main components including Neodymium of a rare earth, iron, and boron. The materials of the Neodymium magnet are expensive and are difficult to be processed. More specifically, the material is very hard, so that it is difficult to produce the magnet by monolithic molding.

The magnets 41a, 42a, 41b, 42b in FIG. 1 according to the first embodiment are formed in a circular arc shape in cross section, there is a problem that it is very difficult to produce the magnet.

More specifically, to produce the magnet having a circular arc shape in cross section, first a magnet formed in a rectangular parallelepiped shape. The circular arc shape is provided by a process of cutting the magnet of the rectangular parallelepiped shape to form to have a circular arc cross section.

Accordingly, this needs much man power for the process and there is loss as a result of cutting a magnet material which is expensive.

<<Advantageous Effect in the Second to Fourth Embodiment Over the First Embodiment>>

Accordingly, the second to the fourth embodiments have an advantageous effect against the first embodiment as follows:

<1> The number of the magnets is two, which is a low number. Because the amount of the material per one magnet is small, the expensive materials for the magnet can be reduced, and the production cost can be reduced.
<2> Because the magnet is formed in the rectangular parallelepiped, so that it is easy to produce the magnet.
<3> Because the magnet is formed in the rectangular parallelepiped, there is no loss in the magnet material in the shaping process.
<4> There is no magnet in the diametrical direction of the rotor, so that the rotor can be made larger than that in case where the same size stator is used.

In other words, it is possible to increase the efficiency with the same motor size.

<5> Because there is low variation in magnetic field generated by ration of the rotor, there is few generation of the eddy currents, so that efficiency can be increased.

More specifically, according to the second to fourth embodiment, there are provided the brushless DC motors at a low cost and the production method is easy.

### <<Advantageous Effect of the First Embodiment Against the Second to Fourth Embodiments>>

The brushless DC motor according to the first embodiment has an advantageous effect over the second to fourth embodiments, because the first embodiment uses four magnets formed in the circular arc shape in cross section, so that there is no torque variation (pulsation) with a larger rotation torque.

### Other Embodiments and Modifications

The present invention is not limited to the embodiments described above, but may includes various embodiment and modifications.

### <<Shape of the Rotor Gap>>

In the first to fourth embodiments, the first rotor gap 51 which is a gap for the rotor (see FIG. 1) has been described as a window shape gap, and the second rotor gap 52 (see FIG. 1) is described as the notch. However, the shape is not limited to this.

For example, in FIGS. 9A and 9B, as the first rotor gap 51, a rectangular or a trapezoid are exemplified. However, other shapes can be used such as a triangle or a circular shape.

Further the first rotor gap 51 is exemplified with gap including three (or four) of window gaps. However, the number of the gaps may be two or less.

The second rotor gap 52 may be a window-like gap or a notch gap.

Further, the shape may be, as described above, a triangle, a rectangular, or other polygonal shapes or a circle. Further, more than one gap are usable.

An improvement in characteristic such as a torque stabilization or efficient can be provided by forming a desired main magnetic flux by a plurality of gaps or notches having various shapes or the arrangement combination.

### <<High Magnetic Resistor>>

As described above, the rotor gap (the first rotor gap 51 and the second rotor gap 52) at the rotor peripheries 32a, 32 (see FIG. 1) in the rotor 30 (see FIG. 1) are gaps having window shapes and the notches in the side surface. However, it is sufficient that these are formed as the high magnetic resistors. Accordingly, the high magnetic resistor can be formed by changing a thickness of steel plate to form the high magnetic resistor. Further, the high magnetic resistor can be formed using a material having a high magnetic resistance.

The high magnetic resistor is not formed with the gaps or the notch in the steel plates, but formed with a thickness change or different materials, there is an advantageous effect in that the stiffness of the rotor 30 can be maintained. Further, the steel plate shape can be formed line-symmetrically. This provides an advantageous effect to secure stabilization during rotation.

### <<Stator Notch <1>>>

Because the first stator notch 61 and the second stator notch 62 of the stator 10 are also high magnetic resistors, various shapes of notches and gaps are usable like the rotor gap of the rotor 30. Further the number of and arrangement of the notches or gaps may be varied and combined. Further, in place of the notches and the gaps, the high magnetic resistors can be provided in accordance with a thickness or materials of the steel plate.

The structures of the first stator notch 61 and the second stator notch 62 have advantageous effects similar to those described with the first rotor gap 51 and the second rotor gap 52.

### <<Stator Notch <2>>>

The second stator notch 62 of the stator 10 may be formed by shortening ends of the first housing member 12 and the second housing member 13,

### <<Shape of the Extending Part>>

In the first embodiment as described above, the extending part 53 (FIG. 1) has a length greater than the interval (distance) L4 between two magnets (for example, 42b and 41a). However, it is not always necessary that the length is greater than L4. Though the interval is less than L4, the counterclockwise rotation and torque can be provided.

Further, in FIG. 1, the shape of the extending part 53 is shown in a rectangular or the rectangular parallelepiped. However, this invention is not limited to these shapes. The extending part 53 may have such a shape to be thinner as approaching the tip thereof (left end in FIG. 1). Further, the extending part 53 may have such a shape that a thickness thereof is decreased as approaching the tip thereof.

Further, as described above, the extending part 53 has a shape of a rectangular or a rectangular parallelepiped. However, a shape of the extending part 53 on the side facing the magnet (for example the magnet 41a) is not a linear in cross section, but may be an arc having a radius smaller than that of the arc of the magnet. Further, the shape may be an arc or other curved line in cross section.

Improvement of the shape may provide further increase in the rotation torque, a high efficiency operation, a reduction in torque variation (pulsation).

### <<The Number of Pairs of Magnets>>

In FIG. 1 in the first embodiment, the motor is formed using four magnets, i.e., two pairs of magnets are used. However, the motor may be formed using more than two pairs of magnets.

In FIG. 17 showing the second embodiment, the motor is formed using two magnets, i.e., two pairs of magnets. However, the motor can be formed including more than one pair of magnets.

In any case, increase in the number of pairs of the magnets may decrease the torque variation (pulsation).

### <<Structure of Magnet in Step Between Housing Members>>

As shown in the cross-sectional diagram in FIG. 21 in the fourth embodiment, the end of the magnet 48a is flush with the bottom surface (wall surface on the side of the magnet 48a) of the step 125d between the upper and lower first housing members 125 and does not protrude.

However, even though the end of the magnet 48a protrudes from the bottom surface (wall surface on the side of the magnet 48a) of the step 125d between the upper and lower first housing members 125, the operation to enhance the magnetic force of the magnet can be expected similarly by elongating the width of contact between the surfaces of the magnet and the surfaces of the first housing member 125 and the second housing member 135.

Further in the case where the end of the magnet 48a is buried in the end surface of the stator 10 corresponding to the bottom surface in the step 125d between the upper and lower first housing members 125, the operation to enhance the magnetic force by the magnet can be expected similarly by elongating a width in such a direction that the magnets 48a, 48b contact with the first housing members 125 and the second housing members 135.

### <<Shape of Magnets>>

In the second to fourth embodiments, the magnet 43a, 43b, 44a, 44b, 48a, 48b have been described as rectangular parallelepiped. The present invention is not limited to this. For example, even though a shape of which part is modified in a side or an angle of the rectangular parallelepiped or the rectangular parallelepiped has a small chip or a thin scratch made during manufacturing, when the magnet has a shape generally belonged to the rectangular parallelepiped, there is the above-described advantageous effect.

### <<Materials of Magnet>>

The second embodiment has been described using the Neodium magnets as the magnets 43a, 43b. However, other types of magnets may provide the same advantageous effect as described in the second embodiment.

### <<Polarity of Magnets>>

In the second embodiment, as shown in FIG. 17, the magnets 43a, 43b have S poles on the upper sides thereof and N poles on the lower sides thereof as shown in FIG. 17. However, the poles of the magnets 43a, 43b are not limited to those in FIG. 17.

It is possible to arrange the magnet to have N poles on the upper sides thereof and S poles on the lower sides thereof. In this case, the rotor 30 rotates in the same direction by reversing the direction of the voltage applied to the excitation coil 20.

### DESCRIPTION OF REFERENCE SYMBOLS

1, 2 brushless DC motor 1f
10 stator
11 coil winding part
12 first housing member
13 second housing member
14 first yoke
15 second yoke
20 excitation coil
20a, 21a upper side coils
20b, 21b lower side coil
30 rotor
31 rotor base (base)
32a, 32b rotor peripheries 32a, 32b
41a, 41b, 42a, 42b, 43a, 43b, 44a, 44b, 48a, 48b magnet
45a, 45b, 46a, 46b, 47a, 47b, 151, 161, 401, 501, 601 region
51 first rotor gap
52 second rotor gap
53 e extending part
61 first stator notch
62 second stator notch (high magnetic resistive)
121d, 125d, 131d, 135d step
K rotation shaft

The invention claimed is:

1. A brushless DC motor comprising:
a stator around which an exciting coil is wound;
a rotor that is housed in the stator and rotatable in a predetermined direction; and
a pair of magnets fixed to the stator, the magnets in the pair facing across a rotation shaft of the rotor as a center.

2. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across the rotation shaft of the rotor as the center;
wherein the rotor comprises: a base extending in a diametrical direction arranged to be accessible to the magnets in accordance with rotation of the rotor; and extending parts extending from both ends of the base part in a predetermined direction; and
wherein each of the magnets generates magnetic flux and is arranged such that the magnetic flux is added to another magnetic flux generated by another adjacent one of the magnets in the circumferential direction in such a state that the magnet is magnetically connected to the adjacent one of the magnets through the extending part.

3. The brushless DC motor as claimed in claim 2,
wherein the extending part extends successively separating from the magnet as the expending part is separating from the rotor.

4. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across a rotation shaft of the rotor as a center; and
wherein a surface of the rotor on a side facing the magnet has a surface having a substantially same area as an area of a surface of the magnet on the side of the rotor or a substantially same facing length between the surfaces of the magnet and the surface of the rotor.

5. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across the rotation shaft of the rotor as the center;
wherein the rotor comprises two rotor peripheries on sides facing the magnet and a rotor base on a side of the rotation shaft, and
wherein an area of a surface of each of the rotor peripheries facing the magnet is greater than an area in the cross section of the base extending in the same direction as the surface of each of the rotor peripheries.

6. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across the rotation shaft of the rotor as the center;
wherein the rotor comprises two rotor peripheries on sides facing the magnet and a rotor base on a side of the rotation shaft; and
wherein an area in the cross section of the rotor base decreases as the area approaches the rotor base, the cross section extending in the same direction as surfaces of the rotor peripheries facing the magnet.

7. The brushless DC motor as claimed in claim 1,
wherein the pair of the magnets comprise a plurality of pairs of the magnets fixed to an inner surface of the stator each spaced at a predetermined interval in a circumferential direction,
wherein the magnets in each of the pairs have different polarities facing each other across the rotation shaft of the rotor as the center;
wherein the rotor comprises a high magnetic resistance part near an area of a surface facing the magnets, the high magnetic resistance part having a magnetic resistance higher than a magnetic resistance of the remaining part of the rotor: and
wherein the high magnetic resistance part comprises formation of a gap in the rotor, change in thickness of the rotor, or formation of a different material.

8. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across the rotation shaft of the rotor as the center;
wherein the stator comprises a high magnetic resistance part at a first housing near a part of the stator around which an exciting coil is wound;
wherein the high magnetic resistance part having a magnetic resistance higher than a magnetic resistance of the remaining part of the rotor; and
wherein the high magnetic resistance part comprises formation of a gap in the rotor, change in thickness of the rotor, or formation of a different material.

9. The brushless DC motor as claimed in claim 1,
wherein the pair of the magnets comprise a plurality of pairs of the magnets fixed to an inner surface of the stator each spaced at a predetermined interval in a circumferential direction;
wherein the magnets in each of the pairs have different polarities facing each other across the rotation shaft of the rotor as the center; and
wherein ends of first and second housing parts of the stator facing a rotation direction of the rotor are made shorter than ends of the magnets, respectively.

10. The brushless DC motor as claimed in claim 1,
wherein the stator comprises a housing that houses the rotor and is formed integrally with a coil winding part around which the exciting coil is wound;
wherein the housing comprises:
a first housing part connected to an end of the coil winding part through a first yoke, one of two pairs of the magnets being fixed to the first housing, and
a second housing part connected to another end of the coil winding part through a second yoke, another one of two pairs of the magnets are fixed to the second housing,
wherein the ends of the first housing and the second housing are separated from each other.

11. The brushless DC motor as claimed in claim 1, wherein the magnets generate a magnetic field in a direction orthogonal with a direction connecting a pair of magnets and with a rotation shaft of the rotor.

12. The brushless DC motor as claimed in claim 11, wherein the pair of magnets generate magnetic fields in the same direction.

13. The brushless DC motor as claimed in claim 11, wherein the stator comprises a first housing and a second housing, wherein the first housing and the second housing have a gap therebetween;
wherein the stator comprises a step in a surface of the first or second housing to have a space having a width which is same as a width of the gap; and
wherein the magnet is arranged in the first or second housing.

14. The brushless DC motor as claimed in claim 11, wherein the magnet comprises a rectangular parallelepiped shape.

15. The brushless DC motor as claimed in claim 14, wherein the magnet comprising the rectangular parallelepiped shape has a lateral width in a direction connecting the pair of magnets is longer than a thickness in a direction orthogonal to the direction connecting the pair of magnets.

16. The brushless DC motor as claimed in claim 13, wherein an end of the magnet protrudes from an end of the stator in the step.

17. The brushless DC motor as claimed in claim 14, wherein an end of the magnet is flush with an end of the stator in the step.

18. The brushless DC motor as claimed in claim 13, wherein an end of the magnet is buried inside an end of the stator in the step.

19. The brushless DC motor as claimed in claim 14, wherein the magnet comprises a Neodymium magnet.
